(19) United States
(12) Patent Application Publication
(10) Pub. No.: US 2026/0363832 A1
(43) Pub. Date: Nov. 19, 2026

(54) ORTHODONTIC DISTALIZER APPLIANCE FEATURES

(71) Applicant: Align Technology, Inc., San Jose, CA (US)

(72) Inventors: David TURNER, Durham, NC (US); Maria ORTIZ PAPARONI, Durham, NC (US); James NISHIMUTA, Durham, NC (US); Jun SATO, San Jose, CA (US); Jie JIANG, Davis, CA (US)

(21) Appl. No.: 19/661,589

(22) Filed: Apr. 28, 2026

Related U.S. Application Data
(60) Provisional application No. 63/796,240, filed on Apr. 28, 2025.

(51) Int. Cl. A61C 7/20; A61C 7/36

(52) U.S. Cl. CPC A61C 7/20; A61C 7/36

(57) ABSTRACT

Orthodontic distalizer appliances and methods for efficient distalization of teeth. An appliance may include an offset region that is configured to receive one or more teeth being distalized and shaped to provide a gap between the appliance and the one or more teeth to allow unconstrained distalization of the one or more teeth. The appliance may include a corrective force feature that is configured to apply a corrective force, which may be different than a distalization force, to a target tooth, which may or may not be a tooth received within the offset region of the appliance. Methods may include integrating distalization in a treatment plan that includes other orthodontic treatments and tooth movements.

### CLAIM OF PRIORITY

This patent application claims priority to U.S. provisional patent application no. 63/796,240, titled “ORTHODONTIC DISTALIZER APPLIANCE FEATURES” and filed on Apr. 28, 2025, herein incorporated by reference in its entirety.

### INCORPORATION BY REFERENCE

All publications and patent applications mentioned in this specification are herein incorporated by reference in their entirety to the same extent as if each individual publication or patent application was specifically and individually indicated to be incorporated by reference.

### BACKGROUND

In orthodontics, distalizing refers to the process of moving a tooth or teeth, particularly molars, distally in the dental arch. Typically, this is done to create space for other teeth, correct malocclusions (e.g., Class II) or improve the alignment of teeth (e.g., bite or overjet issue). During treatment, an appliance conventionally known as a distalizer is applied to the teeth to provide segmental distalization of the canine-to-molar posterior maxillary area or mandibular area. An example of a distalizer appliance is the Carriere motion appliance, an example of which is shown in FIG. 1. The appliance includes a lower polymer retainer 100 that is placed on the lower teeth of the patient. A metal arm (or bar) 102 is bonded to the upper canine via a canine attachment 104 and to the upper first molar via an upper molar attachment 106 on both sides of the patient’s teeth. The upper molar attachment 106 has a ball and socket feature, which enables mesial out rotation of the molar. A lower molar attachment 108, which includes a button or bracket, is bonded on the lower first molar. The lower polymer retainer 100 acts as an anchor. An elastic band 110 is connected to the canine attachment 104 and the lower molar attachment 108 to provide a distalizing force to move the teeth distally, e.g., to realign the bite.

Conventional distalizers, such as the Carriere motion appliance, can generate undesired forces that result in undesirable tooth tipping, such as lingual tipping of the molar and canines. In addition, dental practitioners are generally not given any flexibility as to which teeth the forces are applied to when using conventional distalizers. Furthermore, distalization is conventionally conducted prior to implementing other orthodontic corrections, thereby lengthening the overall orthodontic treatment duration. What is needed are distalizer appliances and methods that address these problems and shortcomings.

### SUMMARY OF THE DISCLOSURE

Described herein are apparatuses (e.g., devices, systems, software and/or firmware) and methods for force-driven distalization while providing other corrective orthodontic movement of a subject’s teeth. The devices may include distalizer appliances (also referred to as “distalizers”) that are configured to promote distalization movement of a segment of teeth rather than individual teeth, thereby providing efficient distalization. In addition, the distalizers may include corrective force features that apply corrective forces to one or more target teeth, thereby providing other orthodontic corrections while the distalization occurs.

The methods and apparatuses may be part of an orthodontic treatment that includes the use of a series of orthodontic aligners, including “shell aligners” that may be removably worn over a subject’s teeth (upper dental arch and/or lower dental arch). In some cases, the distalizers may be integrated as part of a full orthodontic treatment. For example, a treatment plan may include one or more distalization stages in which one or more distalizers are used to implement distalization, and one or more non-distalization stages in which one or more orthodontic aligners are used implement other orthodontic corrections (e.g., without substantial distalization). During orthodontic treatment, the distalizers may be paired with partial active anterior appliances and/or lower arch active appliances to advance dental correction as distalization treatment progresses.

Unlike conventional distalization devices, the distalizers described herein may be configured to be removably worn over the subject’s maxillary (upper arch) teeth, providing ease of use and flexibility. The distalizers may be used in conjunction with a device worn on the subject’s mandibular (lower arch) teeth, such as a removable appliance (e.g., aligner). For example, the distalizers may be configured to couple with elastic bands that are configured to also couple with the lower arch appliance. The elastic bands provide an elastic distalization force that is transmitted through the segment of teeth to distalize the segment of teeth.

Any of the distalizer appliances described herein may be configured as a unilateral or bilateral distalizer. In general, a unilateral distalizer is configured to apply distalization to one side of a dental arch and a bilateral distalizer is configured to apply distalization to both sides of a dental arch.

Any of the distalizer appliances described herein may be made of (or include) a polymer material. For example, a distalizer appliance may be made of a continuous polymeric material. The distalizers may include one type or polymer or more than one type of polymer. The distalizers may be fabricated using any of a number of manufacturing techniques, such as three-dimensional (3D) printing, molding, thermoforming and/or extrusion.

The distalizer appliances described herein may include contact regions that are configured to either directly or indirectly contact the teeth. A contact region may indirectly contact a tooth, for example, by contacting a dental attachment that is attached to the tooth. An offset region of the appliance may refer to a region that receives one or more teeth (e.g., two or more teeth) and is shaped to allow the transmission of a distalization force through the one or more teeth. At least a portion of an offset region may be offset with respect to (i.e., not contact) at least a portion of the teeth received therein, thereby allowing the natural biomechanics of the jaw to provide efficient movement of the teeth being distalized.

According to one example, a dental appliance includes: a tooth receiving portion shaped to receive a plurality of teeth, the tooth receiving portion comprising an elastic engagement structure arranged to engage with an elastic band to apply a distalization force along the plurality of teeth, wherein the tooth receiving portion includes: a first contact region that is shaped to contact one or more first teeth of the plurality of teeth; a second contact region that is shaped to contact one or more second teeth of the plurality of teeth; and an offset region that is arranged to receive one or more intermediate teeth of the plurality of teeth, the one or more intermediate teeth positioned between the one or more first teeth and the one or more second teeth, wherein an inner surface of the offset region is shaped to be offset with respect to the one or more intermediate teeth such that the inner surface of the offset region does not contact the one or more intermediate teeth to allow the distalization force to transmit through the one or more intermediate teeth. The second contact region may be shaped to directly contact the one or more second teeth or indirectly contact the one or more second teeth via one or more dental attachments attached to the one or more second teeth. The one or more intermediate teeth may include a first premolar and/or a second premolar of the plurality of teeth. The second contact region may be configured to contact a buccal surface, a lingual surface or a buccal and lingual surface of the one or more second teeth. The second contact region may include a lingual wall and a buccal wall that encompass the one or more second teeth, wherein at least one of the lingual and buccal walls contact the one or more second teeth.

As described herein, the inner surface of the offset region may be shaped to be offset with respect to the one or more intermediate teeth such that the inner surface of the offset region does not contact the one or more intermediate teeth to allow the distalization force to transmit through the one or more intermediate teeth. Although this may be apparent in the context of the dental appliance, when worn by the subject (e.g., patient), or a model of the subject’s teeth (either virtual or actual), this may also be apparent based on the distance between the opposite walls of the offset region as compared with the opposite walls of the first contact region (that are shaped to contact one or more first teeth) and/or the second contact region (shaped to contact one or more second teeth of the plurality of teeth). Specifically, the distance between the inner surfaces of these opposite walls (on the lingual and buccal sides of the appliance) may be larger for the offset region as compared with the distance between the inner surfaces of the opposite walls on the lingual and buccal sides of the first contact region and the second contact region (e.g., larger by a percentage, such as 2% ,3%, 4%, 5%, 7.5%, 10%, 12.5%, 15%, 20%, 25%, etc.). This is unusual, in that the second contact region may be, for example, a more posterior tooth (e.g., molar), and such teeth typically have larger or equivalent diameters as compared to their anteriorly neighboring teeth. In any of these examples, the occlusal side of the offset region may also be distinct from the occlusal sides of the first contact region and/or the second contact region. For example, the occlusal sides may be relatively smooth or smoother than the occlusal sides of the first contact region and/or second contact region. The height of the occlusal side of the offset region may also be larger than the height of the occlusal side of the first contact region and/or the second contact region (e.g., larger by a percentage, such as 5%, 10%, 15%, 20%, 25%, etc.).

The dental appliance may include two tooth receiving portions. For example, a first tooth receiving portion may be shaped to accept a first plurality of teeth on a first side of a dental arch and a second tooth receiving portion may be shaped to accept a second plurality of teeth on a first side of the dental arch.

Any of the distalizer appliances described herein may include a transpalatal region that connects the tooth receiving portion, for example, at opposite sides of a dental arch. The transpalatal region may be arranged to span a palate of the dental arch. In some examples, the transpalatal region may have an anterior edge that is anterior to a premolar region of a tooth receiving portion. In some examples, the transpalatal region may have a varied thickness along one or more axes (e.g., a posterior-anterior axis and/or a buccal-lingual axis).

The distalizer appliances may include one or more corrective force features that may be configured to apply one or more corrective forces on one or more teeth. The corrective force applied in a different direction than the distalization force. The corrective force may include, for example, a translation, tipping, intrusion, extrusion, uprighting or torquing force applied to a target tooth. For example, a second contact region and/or an offset region may include a corrective force feature to apply a corrective force on the one or more second teeth. As another example, an offset region may include an attachment engagement feature (e.g., that protrudes from an inner surface of the offset region to maintain the offset between the inner surface and the teeth being distalized) that corresponds to a corrective force feature to apply a corrective force on a tooth that is being distalized.

The appliances described herein may include any number of elastic engagement structures, which may be located at any of a number of places of the appliance. For example, the elastic engagement structure may be located on a buccal side of a cavity of the appliance that is configured to accept a canine tooth or premolar tooth (e.g., the first contact region). Alternatively or additionally, an elastic engagement structure may be located on a buccal side of an offset region (over teeth being distalized) that is located distal to the cavity that is configured to accept the canine tooth or premolar tooth.

A tooth receiving portion may include one or more elastic engagement structures that are configured to engage with one or more elastic bands. The elastic engagement structure(s) may be located in any of a number of locations. For example, the elastic engagement structure(s) may be along a buccal side of the tooth receiving portion. In some examples, one or both sides of an appliance may include multiple elastic engagement structures. The multiple elastic engagement structures allow a user to choose among different locations as to where to hook an elastic band to generate the distilization force vector. In some cases, multiple elastic bands may be coupled with multiple elastic engagement structures at the same time to generate multiple force vectors.

In some examples, the offset region may include an occlusal cutout that is arranged to expose occlusal surfaces of the one or more intermediate teeth. In other examples, the offset region covers at least a portion of the occlusal surface of at least one tooth that is received within the offset region.

According to another example, a method, e.g., of distalizing a subject’s teeth, may include: applying a dental appliance over a subject’s upper dental arch such that a plurality of teeth of the subject’s upper dental arch are received in a tooth receiving portion of the dental appliance, wherein the tooth receiving portion contacts one or more first teeth of the plurality of teeth and one or more second teeth of the plurality of teeth, wherein an offset region of the tooth receiving portion includes an inner surface that is offset with respect to one or more intermediate teeth between the one or more first and second teeth; and coupling an elastic band to an attachment site on the dental appliance and to an attachment site on the subject’s lower jaw to apply a distalization force that is transmitted through one or more intermediate teeth of the subject’s upper dental arch. The attachment site on the subject’s lower jaw may be an elastic engagement structure of a lower jaw appliance and/or a Temporary Anchorage Device (TAD) in the subject’s lower jaw.

According to further example, a dental appliance includes: a tooth receiving portion shaped to receive a plurality of teeth, the tooth receiving portion comprising an elastic engagement structure arranged to engage with an elastic band to apply a distalization force along the plurality of teeth, wherein the tooth receiving portion includes: an offset region that is arranged to receive one or more teeth of the plurality of teeth that are to be distalized, wherein an inner surface of the offset region is shaped to be offset with respect to the one or more teeth such that the inner surface of the offset region does not contact the one or more teeth to allow the distalization force to transmit through the one or more teeth; and a dental attachment engagement feature that protrudes from the inner surface of the offset region and is arranged to engage with a dental attachment bonded to a target tooth of the one or more teeth to apply a corrective force on the target tooth, wherein the corrective force is in a different direction than the distalization force. The tooth receiving portion may further include: a first contact region that is shaped to contact one or more first teeth of the plurality of teeth; and a second contact region that is shaped to contact one or more second teeth of the plurality teeth, wherein the offset region may be arranged to accept one or more intermediate teeth of the plurality of teeth, the one or more intermediate teeth positioned between the one or more first teeth and the one or more second teeth.

Described herein are methods for integrating a distalization treatments into a dental treatment plan. For example, a user (e.g., doctor) may modify a virtual representation of an upper dental arch by removing the posterior upper teeth from consideration in one or more stages of the treatment plan to correct anterior crowding (e.g., using one or more non-distalizing aligners).

For example, according to another example, a method (e.g., of dental treatment planning) may include: accessing a digital dentition model of a subject’s dentition prior to a dental treatment plan or at an intermediate stage of the dental treatment plan, wherein the digital dentition model includes an upper dental arch and a lower dental arch, wherein the upper dental arch includes posterior teeth and anterior teeth, wherein the one or more of the posterior teeth are subject to distalization according to the dental treatment plan; modifying the upper dental arch by removing the posterior teeth from the digital dentition model; presenting the upper dental arch with the anterior teeth and without the posterior teeth; determining alignment forces for aligning at least one anterior tooth of the anterior teeth, wherein the posterior teeth are not considered when determining the alignment forces for moving the at least one anterior tooth; generating one or more removable partial anterior appliances for applying the alignment forces to the at least one anterior tooth according to one or more treatment stages of the dental treatment plan; and generating one or more removable distalization appliances for implementing the distalization to the upper dental arch according to the one or more treatment stages of the dental treatment plan, wherein each of the one or more removable distalization appliances includes a tooth receiving portion shaped to receive the posterior teeth and to apply a distalization force on the one or more of the posterior teeth. The method may further include determining second alignment forces for aligning at least one lower tooth of the lower dental arch according to the one or more stages of the treatment plan. The method may further include generating one or more removable lower dental arch appliances for applying the second alignment forces to the at least one lower tooth. The one or more treatment stages may include at least partial simultaneous application of alignment forces on the at least one anterior tooth of the one or more anterior teeth of the upper dental arch and application of the distalization force on the one or more of the posterior teeth of the upper dental arch. Aligning the at least one anterior tooth of the anterior teeth may include correcting crowding of the anterior teeth. At least one of the removable partial anterior appliances may be configured to be worn on the upper dental arch as the same time as at least one of the removable distalization appliances. The method may further include determining one or more distalization stages for distalizing the one or more posterior teeth. The one or more distalization treatment stages may include an ordered series of distalization treatment stages involving the use of an ordered series of dental appliances, each of the series of dental appliances having a corresponding offset region having an inner surface that is arranged to be offset by a different distance with respect to at least two teeth of the one or more posterior teeth.

According to another example, a dental appliance system includes: a first dental appliance shaped to receive a plurality of posterior teeth of an upper dental arch wherein the first dental appliance includes a first elastic engagement structure that is arranged to engage with an elastic band; a second dental appliance shaped to receive one or more anterior teeth of the upper dental arch, the second dental appliance configured to apply alignment forces on at least one anterior tooth of the one or more anterior teeth; and a third dental appliance shaped to receive one or more teeth of a lower dental arch, the third dental appliance including a second elastic engagement structure that is arranged to engage with the elastic band, wherein the first dental appliance is configured to apply a distalization force along the plurality of posterior teeth of the upper dental arch when first and third dental appliance are worn and the elastic band is engaged with the first and second elastic engagement structures. The first and second dental appliances may be configured to be worn simultaneously on the upper dental arch. The first, second and third dental appliances may be configured to be worn simultaneously on the upper and lower dental arches. Each of the first, second and third dental appliances may be configured to be removable from respective upper and lower dental arches, The first dental appliance may include: a first contact region that is shaped to contact one or more first teeth of the plurality of posterior teeth; a second contact region that is shaped to contact one or more second teeth of the plurality of posterior teeth; and an offset region that is arranged to receive one or more intermediate teeth of the plurality of posterior teeth, the one or more intermediate teeth positioned between the one or more first teeth and the one or more second teeth, wherein an inner surface of the offset region is shaped to be offset with respect to the one or more intermediate teeth such that the inner surface of the offset region does not contact the one or more intermediate teeth to allow the distalization force to transmit through the one or more intermediate teeth. The first dental appliance may further include a transpalatal region that connects the tooth receiving portion to a second tooth receiving portion and is arranged to span a palate of the upper dental arch, wherein the transpalatal region has an anterior edge that is anterior to a premolar region of the tooth receiving portion.

It should be appreciated that all combinations of the foregoing concepts and additional concepts discussed in greater detail below (provided such concepts are not mutually inconsistent) are contemplated as being part of the inventive subject matter disclosed herein and may be used to achieve the benefits described herein.

Also described herein are orthodontic appliances, systems, and fabrication methods for correcting Class III malocclusions and, in particular, patient‑specific removable distalizer appliances configured for use on a lower dental arch. The appliances are designed to distalize posterior mandibular teeth while minimizing unwanted forces on anterior teeth and simultaneously enabling additional orthodontic tooth movements.

In one aspect, the disclosure provides a removable orthodontic appliance formed as a monolithic, patient‑specific polymer body configured to be worn on a lower dental arch. The appliance includes right and left posterior sections shaped to wrap around posterior teeth, including canines, premolars, and molars. Each posterior section incorporates a tooth‑engaging hull that surrounds selected teeth and is configured to transmit distalizing forces efficiently through the posterior segment.

The appliance further includes one or more tooth hull fillers disposed within the posterior sections. The tooth hull fillers define occlusal surfaces configured to contact opposing teeth of the upper dental arch. These occlusal surfaces function as occlusal deprogrammers to reduce intercuspation and as force transmitters for distalizing mechanics. In some implementations, the occlusal surfaces are substantially planar, while in other implementations they include internal cusp‑matching features that selectively provide full cusp contact, full cusp clearance, or targeted cusp contact to promote intrusion, extrusion, or root control of selected teeth.

An anterior cutout region is defined between the right and left posterior sections and is configured to avoid contact with anterior teeth of the lower arch. This anterior opening leaves the incisors unconstrained, thereby reducing unwanted incisal forces and allowing efficient posterior distalization without incisal restrictions. The anterior cutout region may be formed on the buccal side of the appliance and may be defined by a connection feature that joins the right and left posterior sections.

In some embodiments, the connection feature comprises a buccal lip bumper extending between the right and left posterior sections. The lip bumper is spaced anteriorly from the lower anterior teeth and may be configured to transmit additional distalizing force derived from the patient’s lower lip musculature. In other embodiments, the connection feature comprises a lingual strip extending between the posterior sections along the lingual side of the dental arch. The lingual strip provides structural rigidity sufficient to accommodate distalization forces while remaining offset from anterior teeth to minimize unwanted tooth contact. The width, thickness, and anterior separation of the lip bumper or lingual strip may be customized based on patient anatomy, desired appliance stiffness, or treatment progression.

The appliance further includes one or more elastic engagement structures, such as self‑supported buttons, integrally formed as unitary features of the polymer body. These elastic engagement structures are configured to engage Class III elastics for bite correction and posterior distalization. The position and geometry of the elastic engagement structures may be selected to control the magnitude and direction of applied force vectors.

In certain implementations, the posterior tooth‑engaging hulls include offset regions in which an inner surface of the appliance is spaced from one or more posterior teeth. These offset regions permit force‑driven distal movement of the teeth without constraining movement by appliance contact, while allowing crown‑to‑crown force transmission through the posterior segment. Selective additive material may be applied at specific regions of the hulls to control tipping, rotation, or mesial movement of targeted teeth.

The appliance may additionally include canine bite ramps formed integrally with the tooth hull fillers to counteract canine extrusion that can occur during elastic wear. Occlusal thickness of the tooth hull fillers may be varied along the appliance to open the patient’s bite, provide anterior collision avoidance between upper and lower incisors during jaw movement, and prevent gingival displacement of the appliance during biting. In some embodiments, increased occlusal thickness is achieved using hollow or partially hollow internal features reinforced with internal ribs to reduce material usage while maintaining structural integrity.

The appliances described herein are fabricated by direct additive manufacturing from a digital model of the patient’s dentition. In one aspect, a method is provided in which a digital model of a lower dental arch is obtained, an appliance boundary is generated to define posterior coverage and an anterior cutout region, tooth‑specific hull and hull filler geometries are computed, and a connection feature joining right and left posterior sections is defined. Region‑specific offsets and thickness variations are applied to customize force systems for selected teeth, and the appliance is then fabricated as a single, unitary structure using an additive manufacturing process and a biocompatible polymer material.

In some implementations, the appliance is provided as one of a series of patient‑specific appliances, each having different occlusal thicknesses, offsets, or connection feature geometries. The series of appliances may be used sequentially to provide progressive Class III correction while simultaneously accommodating orthodontic tooth movement and changes in patient anatomy over the course of treatment.

Together, the disclosed appliances and methods provide a removable, directly fabricated Class III distalizer system that enables efficient posterior distalization, improved force control, enhanced patient comfort, and flexible integration into customized orthodontic treatment plans. The processes and steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

These and other aspects and details are described herein.

### BRIEF DESCRIPTION OF THE DRAWINGS

Novel features of embodiments described herein are set forth with particularity in the appended claims. A better understanding of the features and advantages of the embodiments may be obtained by reference to the following detailed description that sets forth illustrative embodiments and the accompanying drawings.

FIG. 1 illustrates a perspective view of an example Carriere motion appliance.

FIG. 2 illustrates a perspective view of an example dental apparatus that is configured to distalize teeth, shown on a model of an upper and lower jaw.

FIGS. 3A-3C illustrate examples of distalizers designed to minimize or avoid forces on one or more teeth: FIG. 3A shows a top view of an example distalizer that includes a local surface offset; FIG. 3B shows a top view of an example distalizer that includes a “bubbling-out” region; and FIG. 3C shows a top view of an example distalizer that includes occlusal cut-outs.

FIGS. 4A and 4B illustrate an example of how a distalizer dental apparatus may include contact and non-contact regions: FIG. 4A is a top overlay view showing regions of dental arch that can be covered by a distalizer; and FIG. 4B the top overlay view of FIG. 4A with indications showing selective contact zones and selective isolation zones of the dental arch.

FIGS. 5A-5C illustrate an example of a distalizer dental apparatus with an elastic engagement structure (e.g., a button or hook) in relation to an offset region of the distalizer: FIG. 5A shows a top perspective view of the distalizer; FIG. 5B shows a bottom perspective view of the distalizer; and FIG. 5C shows a top view of the distalizer with an elastic band.

FIG. 6 illustrates a side view of an example distalizer with elastic engagement structures (e.g., buttons or hooks), showing forces in relation to elastic anchor points.

FIGS. 7A-7D illustrate an example distalizer that includes multiple elastic engagement structures (e.g., buttons or hooks) arranged to provide options for modulating distalization forces: FIG. 7A shows a front view; FIG. 7B shows a top view; FIG. 7C shows a right side view; and FIG. 7D shows a left side view.

FIG. 8 illustrates section view of a portion of an example distalizer that includes a dental attachment engagement feature that is configured to apply force to a dental attachment.

FIGS. 9A and 9B illustrate another example of a distalizer that includes an internal feature that is configured to apply force to a dental attachment: FIG. 9A shows a perspective view; and FIG. 9B shows a closeup view of the internal feature.

FIGS. 10A and 10B illustrate another example of a distalizer that includes an internal feature that is configured to apply force to a dental attachment: FIG. 10A shows a side view of an outline of the distalizer over teeth at the beginning of a distalization treatment; FIG. 10B shows a side view of an outline of the distalizer over the teeth after distalization treatment.

FIGS. 11A and 11B illustrate an example of a distalizer having a transpalatal region with a varied thickness: FIG. 11A shows a top perspective view of the distalizer; and FIG. 11B shows a medial cross-sectional view of the transpalatal region.

FIGS. 12A and 12B illustrate examples of how a distalization can be integrated with orthodontic treatment planning: FIG. 12A illustrates an example of upper and lower dental arch models for a treatment plan, where an upper dental arch is modified so that the treatment plan can apply corrective movements to anterior teeth; and FIG. 12B illustrates an example of upper and lower dental appliances for implementing distalization of upper posterior teeth and alignment of upper anterior teeth.

FIG. 13 is a flowchart illustrating an example process for generating a treatment plan that includes distalization and making a distalizer.

FIGS. 14A-14F illustrate an example of a Class III Distalizer Appliances for Direct Fabrication as described herein including a lip bumper region.

FIGS. 15A-15F illustrate an example of a Class III Distalizer Appliances for Direct Fabrication as described herein including a lingual strip.

FIG. 16A shows an example of a mold of a subject’s lower jaw (not shown) that may be used to generate a distalizer.

FIG. 16B is a table illustrating examples of segments used to form part of a distalizer from a mold such as the one shown in FIG. 16A.

FIGS. 17A-17B illustrate an example showing specified boundaries for forming a distalizer.

FIGS. 18A-18I illustrate one method of forming a distalizer from a mold of a subject’s teeth.

FIG. 19 shows an example of a partial design for fabricating a distalizer as described herein.

FIG. 20 is an example of a partial design for fabricating a distalizer.

FIGS. 21A-21D illustrate examples of distalizers configured to have different cusp contacts within the occlusal region of the distalizer.

FIGS. 22A-22B illustrate the effect of relative occlusal thickness on a distalizer as described herein.

FIGS. 23A-23B illustrate different occlusal heights for a distalizer as described herein.

FIG. 24 shows an example of a distalizer having an enlarged occlusal region.

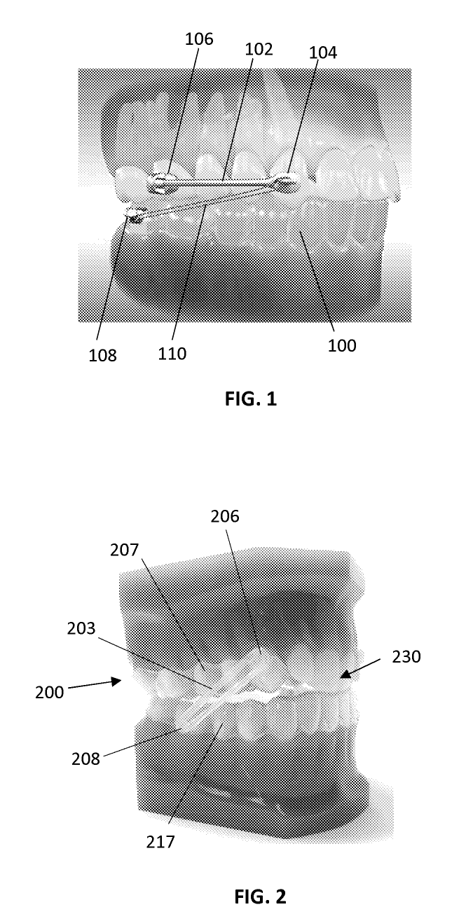

### DETAILED DESCRIPTION

The apparatuses and methods described herein include distalizer appliances (“distalizers”) that are configured to distalize posterior segments of teeth. The distalizers may be used in conjunction with a device worn on the subject’s mandibular (lower arch) teeth, such as a removable appliance (e.g., aligner). FIG. 2 shows an example of a distalizer 200 that includes a pair of tooth segment regions 207 for the upper teeth (applied over the molars, premolars and canines). The distalizer 200 includes an elastic engagement structure 206 (e.g., hook or button) on a buccal surface of the distalizer 200 over the canine teeth, which is configured to engage with an elastic band 203. The elastic band 203 also engages with an attachment feature 208 (e.g., hook or button) of a lower device 217 (aligner) on the lower teeth. This example includes buccal-side cutouts for the incisors 230. In this case, the elastic band 203 applies a distalization force on the canine tooth where the elastic engagement structure 206 is located over.

Any of the distalizers described herein may be patient-removable appliances. For example, the distalizers may be able to be removed from the subject’s teeth without un-bonding any part of the device from the subject’s teeth and/or without the use of specialized tools. This can allow flexibility as to when the appliance is worn by the subject and leave open the possibility of other dental and/or orthodontic treatments to be implemented during the distalization treatment period.

Any of the distalizers may include features to improve performance, such as a transpalatal region that extends between the tooth segment regions that is configured to reduce undesirable tipping and/or rotation of the teeth, and/or a disoccluder on an outer occlusal surface of the device that is configured to reduce undesirable intercuspation with opposing teeth. Examples of distalizer appliances and associated methods are described in International Patent App. No. PCT/US2023/073973, titled “ORTHODONTIC DISTALIZER APPARATUS AND METHODS,” filed on Sep. 12, 2023, and published as International Pat. Pub. No. WO 2024/059560, which is incorporated by reference herein in its entirety. The apparatuses and methods described herein include additional and/or alternative features for providing efficient distalization, applying other corrective forces while distalization occurs, customization options for dental practitioners for implementing distalization, and flexible options for incorporating distalization in overall treatment planning.

The distalizers described herein may be configured to avoid or minimize forces and/or moments acting a segment of teeth being distalized that would otherwise constrain the segment of teeth from efficient distalization movement. For example, compared to conventional aligners that allow displacement of each tooth by only to a certain extent based on the geometry of the aligner, the distalizers described herein include offset regions that have an inner surface(s) that is offset with respect to certain teeth in the segment of teeth, thereby allowing the distalization force (provided by the elastic band) to be transmitted unconstrained through the teeth being distalized. Such force-driven distalization devices allow the biomechanics of the subject’s jaw (i.e., via soft tissue, periodontal ligament) to transmit the distalization force, which can be more efficient than displacement-driven devices (e.g., conventional aligners).

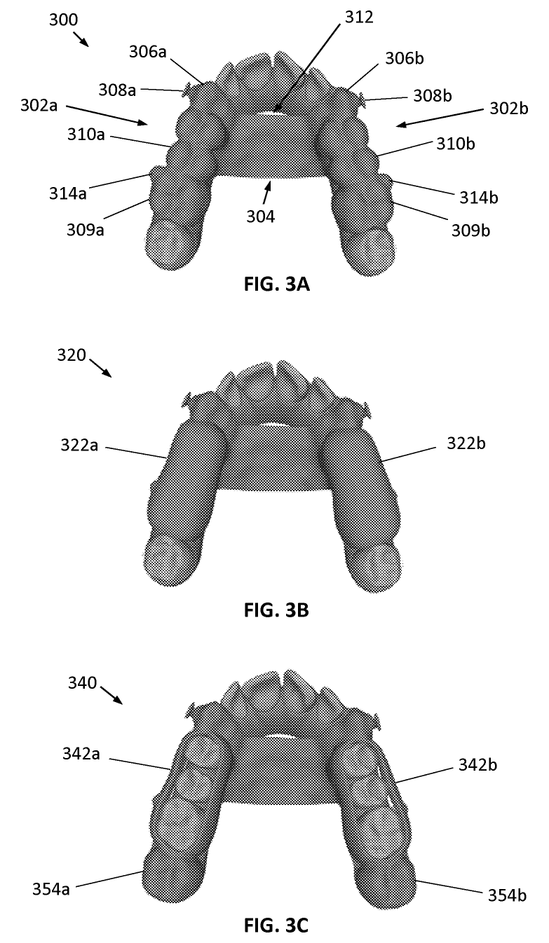

For example, FIGS. 3A-3C show examples of dental appliances that are configured to avoid or minimize forces and/or moments acting on teeth for distalization. FIG. 3A shows a distalizer 300 that includes a first tooth receiving portion 302a and a second tooth receiving portion 302b that are each shaped to receive teeth on opposite sides of a dental arch. In this example, the first tooth receiving portion 302a includes a first right contact region 306a that is configured to contact the right upper canine, and a second right contact region 309a that is configured to contact the right upper first molar. Likewise, the second tooth receiving portion 302b includes a first left contact region 306b that is configured to contact the left upper canine, and a second left contact region 309b that is configured to contact the left upper first molar. In some cases, the inner surface of the second right and left contact regions 309a, 309b do not directly contact the underlying molars, but rely on indirect contact via first and second dental attachment engagement features 322a, 322b, which contact dental attachments bonded to the underlying molars.

The first right contact region 306a includes a first elastic engagement structure 308a (e.g., hook or button), and the first left contact region 306b includes a second elastic engagement structure 308b (e.g., hook or button). Each of the first and second elastic engagement structures 308a, 308b is configured to engage with an elastic band that engages with an attachment site on the subject’s lower jaw. For example, the attachment site may be a corresponding elastic engagement structure of a lower device (e.g., aligner) on the subject’s lower jaw. Alternatively or additionally, the attachment site on the subject’s lower jaw may be a Temporary Anchorage Device (TAD), which is typically a surgically placed implant (e.g., screw) to provide a stable anchor point. The force created by the elastic bands applies or enhances a distalization force on the canines, which is transmitted along the corresponding segment (e.g., row) of teeth to shift the teeth distally.

The first and second tooth segment regions 302a, 302b include first and second offset regions 310a, 310b, respectively. The first offset region 310a is arranged to receive one or more intermediate teeth between the teeth accepted by the first right contact region 306a and the second right contact region 314a. Likewise, the second offset region 310b is arranged to receive one or more intermediate teeth between the teeth accepted by the first left contact region 306b and the second left contact region 314b. In this example, each of the first and second offset regions 310a, 310b is configured to be positioned over respective first and second premolars. Each of the first and second offset regions 310a, 310b has an inner surface that is offset with respect to the intermediate teeth received therein. That is, the inner surface of each of the first and second offset regions 310a, 310b is offset with respect to lingual, buccal and occlusal surfaces of the intermediate teeth (premolars) in which they cover such that the inner surfaces of the first and second offset regions 310a, 310b do not contact (or minimally contact) the underlying teeth. Since the inner surfaces of the first and second offset regions 310a, 310b are offset with respect to the intermediate teeth (premolars), there is space between the inner surfaces of the first and second offset regions 310a, 310b and the underlying teeth when the dental appliance 300 is worn on the dental arch. This avoids or minimizes any forces and/or moments from acting on the intermediate teeth as the distalizing force is applied. Avoiding or minimizing active forces on these teeth can allow the distalization forces to shift these teeth without interference from contact with the dental appliance 300 itself. This approach takes advantage of natural biomechanics and may be advantageous for natural alignment, up-righting, and efficient movement of the teeth as compared to staged or attachment-based force systems.

A transpalatal region 304 extends between and connects the first and tooth receiving portion 302a, 302b. The transpalatal region 304 can be configured to provide support and redistribute the force in facial and palatal directions. The transpalatal region 304 can apply a counter moment to the teeth to prevent or reduce lingual tipping of the molars and/or canines and can constrain their mesial-out rotation when distalizing force is applied, e.g., by the elastic band. The transpalatal region 304 may also improve the integrity and strength of the distalizer 300, reducing or preventing the need for reinforcement by, e.g., an anterior lingual bar which may otherwise cause discomfort. Thus, the transpalatal region 304 can provide strength to prevent structural damage to the distalizer while reducing tongue irritation compared to, e.g., an anterior lingual bar. In this example, the transpalatal region 304 has an anterior edge 312 that is anterior to the offset regions 310a and 310b. The transpalatal region 304 is also coupled with at least a portion of the first contact regions 306a, 306b (e.g., coupled to the cavity that cover the canines and that include the elastic engagement structures 308a, 308b. In addition, the transpalatal region 304 is coupled to at least part of the offset regions 310a, 310b. This anterior position of the transpalatal region 304 can provide good support for the distalizing forces.

As discussed, the second right and left contact regions 309a, 309b include first and second dental attachment engagement features 322a, 322b, respectively, which are arranged to engage with corresponding dental attachments bonded to corresponding molars. In this example, the first and second dental attachment engagement features 322a, 322b are small cavities within the inner walls of the second right and left contact regions 309a, 309b that are shaped and arranged to receive and engage with a dental attachment bonded to the respective molars. In some cases, the engagement with the dental attachments is only for anchoring the posterior part of the appliance 300 to the patient dental arch. In other examples, engagement with the dental attachments is for providing corrective forces to target teeth – in this case, right and left first molars. The corrective force may be applied to provide orthodontic corrections (e.g., other than distalization) while the distalization occurs. The corrective forces may be applied in a different direction than the distalization force and may enhance or counter the distalizing force. Examples of corrective forces may include a translation force, a tipping force, an intrusion force, an extrusion force, an uprighting force, a torquing force and/or other corrective force.

FIG. 3B shows an example distalizer 320 that has similar features as the distalizer 300 of FIG. 3A, except that the offset regions 322a, 322b do not have tooth-shaped outer surfaces as with the distalizer 300. Instead, the outer surfaces of the offset regions 322a, 322b have a “bubbled out” shape. This variation may provide more space between the inner surfaces of the offset regions 322a, 322b to ensure they do not contact the first and second premolars, whereas the tooth-shaped outer surfaces of distalizer 300 (FIG. 3A) may be less bulky, and may thereby provide more comfort, and/or provide a more aesthetic look.

FIG. 3C shows an example distalizer 340 that has similar features as the distalizers of FIGS. 3A and 3B except that the distalizer 340 includes posterior cavities 354a, 354b that are configured to cover the posterior-most molars (in this case, the second molars), and that the offset regions 342a, 342b of the distalizer 340 include occlusal cut-outs. The posterior cavities 354a, 354b may be configured to contact the second molars, and therefore, may be referred to as contact regions. The occlusal cut-outs expose the occlusal surfaces of the underlying teeth (in this case, the first premolars, the second premolars, and the first molars), providing another way to ensure that the distalizer 340 does not contact the underlying teeth. The optional posterior cavities 354a, 354b may provide structural integrity to the distalizer 340 due to the lesser material caused by the occlusal cut-outs and/or help maintain the distalizer 340 in place over the dental arch.

As discussed, the dental appliances described herein may include corrective force features for applying forces other than the distalization force(s). In some examples, the corrective force features may correspond to select regions of the walls of the distalizer that are configured to selectively contact some teeth (or certain portions of the teeth) to promote specific orthodontic movements, while other regions of the walls are configured to avoid contact with other teeth (or certain portions of the teeth) to promote the force-driven distalization. For example, a distalizer can be configured to contact and apply forces on the crowns of selected teeth to control or limit movements that may be imparted by crown-contact forces during segmental movements in distalization.

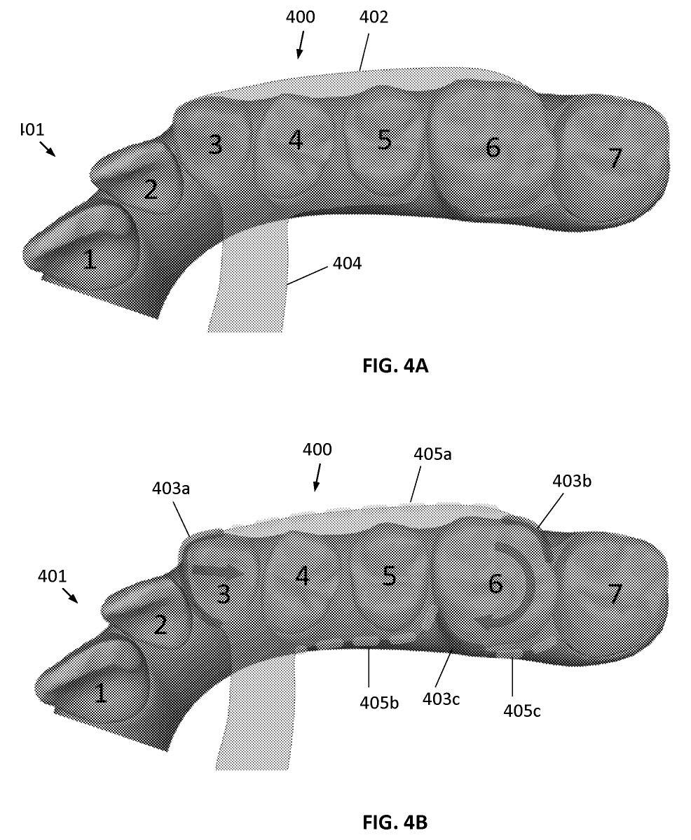

For instance, FIGS. 4A and 4B illustrate an example dental appliance 400 that is configured to apply forces to selective contact zones of a dental arch while allowing selective isolation zones of the dental arch. FIG. 4A shows a silhouette/outline of a distalizer 400 overlaid on a portion of a dental arch 401. In this example, a tooth segment region 402 of the distalizer 400 covers a canine (3), a first premolar (4), a second premolar (5), a first molar (6) and a second molar (7). A transpalatal region 404 extends between the tooth segment region 402 and another tooth segment region on the opposite side of the dental arch 401.

FIG. 4B shows how the dental appliance 400 includes contact regions 403a, 403b and 403c, in which the walls of the appliance 400 are shaped to contact selective contact zones of the dental arch 401, and includes non-contact regions 405a, 405b and 405c (of an offset region) that are configured to not contact selective isolation zones of the dental arch 401. In this example, a first contact region 403a is configured to apply a distalizing force on the canine (3), indicated as an arrow on the canine (3). The non-contact regions 405a and 405b have an inner surface that are offset with respect to the first premolar (4) and the second premolar (5) to allow unrestricted transfer of the distalizing force in the distal direction toward the first molar (6). A crown contact point between the second premolar (5) and the first molar (6) can impart an uncontrolled distalizing point-force against the first molar (6), which may be biomechanically desirable. In this case, since mesial-out rotation of the first molar (6) is also desirable to create anterior space in distalization, the appliance 400 has non-contact regions 405a and 405c that are configured to be offset with respect crowns of targeted isolation zones on the mesial and/or distal regions on the buccal and/or lingual aspects of the first molar (6) to allow free rotation only in this direction (mesial-out rotation), while restricting rotation in the opposite direction (mesial-in rotation) by contact regions 403b and 403c. This configuration promotes rotation in one direction, shown as a curved arrow on the first molar (6), without restraining rotation in opposite direction on the same axis. In other examples, a distalizer may alternatively or additionally be configured to promote other types of tooth movements (e.g., translation, tipping, intrusion, extrusion, uprighting, torquing, etc.).

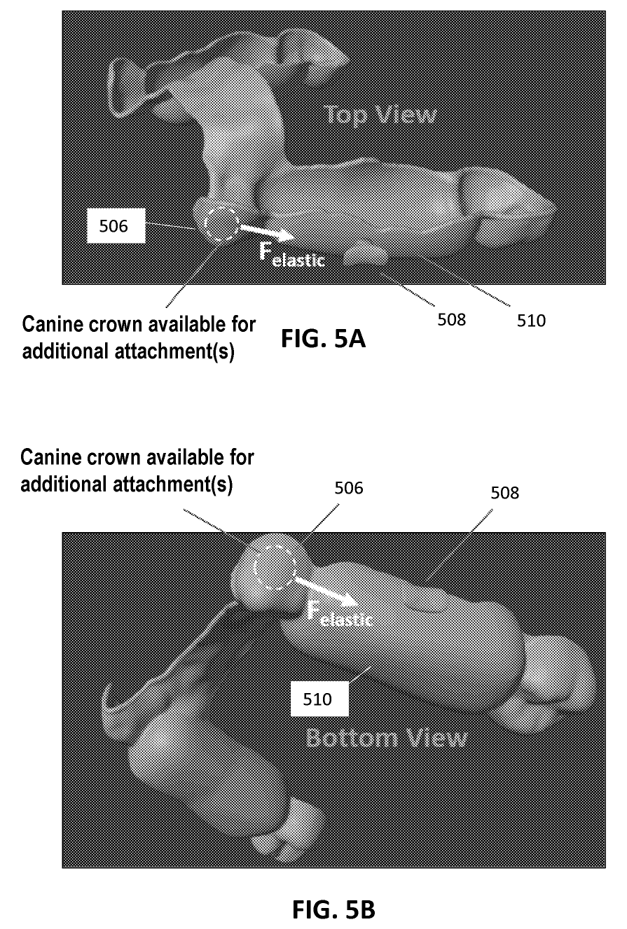

In some examples, a distalizer may include one or more elastic engagement structures (e.g., hooks or buttons) that is/are located at specific area(s) other than over the canine tooth. For example, the elastic engagement structure may be positioned on offset region of the appliance to create a customized distalizing force on a dental arch. FIGS. 5A and 5B show an example of an appliance that includes an elastic engagement structure 508 that is located on an outer buccal surface of an offset region 510. The elastic engagement structure 508 is configured to engage with an elastic band 511 that can also be engaged with a corresponding elastic engagement structure on a dental appliance (e.g., aligner) on the lower dental arch. A cavity 506 that fits over the canine may be configured to contact the canine so that the elastic distalizing force is transmitted through the appliance to the canines, even though the elastic engagement structure 508 is located distal to the cavity 506, as illustrated in the example of FIG. 5C. The elastic engagement structure 508 may be positioned at different locations along the offset region 510. For example, the elastic engagement structure 508 may be located distal to a cavity 507 that is configured to accept a first premolar. In cases where there is no canine coverage by the appliance (i.e., patients with no canines, impacted canines, or canines that are excluded from distalization treatment for any other reason.), the first tooth covered by the appliance may be the first premolar.

Variable placement of the elastic engagement structure (e.g., hook or button) allows more precise control of the distalizing force vector from the elastic band, which is typically only available in a limited number of options (e.g., 6 ounce or 8 ounce). With additional flexibility to place the elastic engagement structure (e.g., hook or button) on other parts of the appliance, the overall force magnitude as well as the force vector direction (vertical and horizontal components) can be tailored for each treatment or stage. This can be taken advantage of to minimize or promote certain orthodontic tooth movements, such as canine extrusion, molar tipping, and molar extrusion, based on treatment needs.

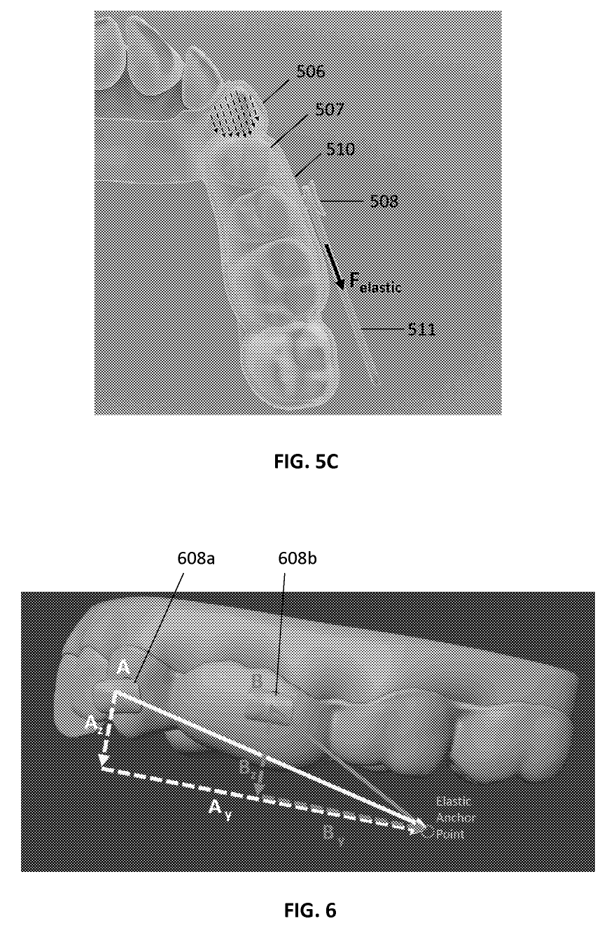

FIG. 6 shows an example of a distalizer with a first elastic engagement structure 608a and a second elastic engagement structure 608b. An elastic band engaged with the more distal second elastic engagement structure 608b and an elastic anchor point on a lower dental appliance will lead to lower distalizing force(s) and an enhanced vertical component of the force(s). Conversely, an elastic band engaged with the more anterior first elastic engagement structure 608a and the elastic anchor point on the lower dental appliance will lead to greater distalizing force(s) and an enhanced horizontal component of the force(s). Occlusal plane rotations can also be controlled using this method. For example, an elastic engagement structure with more distal placement used with a heavy elastic increase the vertical force vector to facilitate lower molar extrusion and enhance occlusal plane rotation.

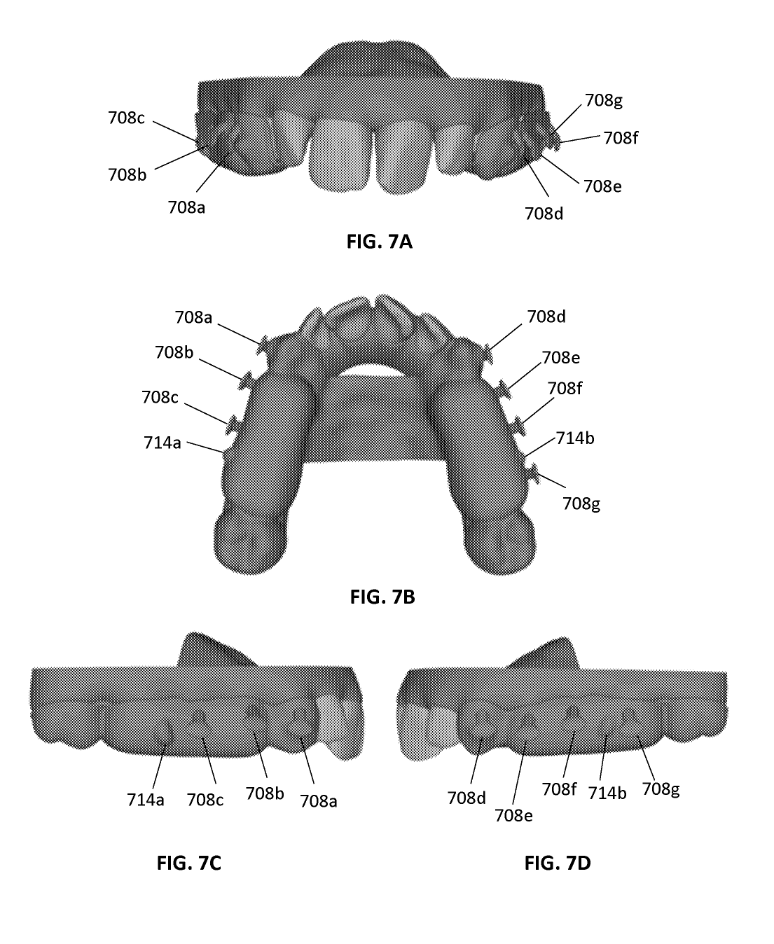

FIGS. 7A-7D shows an example distalizer appliance that includes multiple elastic engagement structures (e.g., buttons or hooks) 708a-708g arranged to provide options for modulating distalization forces. The multiple elastic engagement structures 708a-708g can provide different options to modulate distalization forces according to the patient’s response and doctor’s requirements as treatment evolves. Additionally or alternatively, different elastic engagement structures 708a-708g can be used at different stages of a treatment plan. In some cases, multiple elastic bands may be used one or both sides of the appliance at the same time. For example, two or more of the elastic engagement structures 708a-708g on the same side of the dental arch may have elastic bands mounted on them to provide corresponding two or more different force vectors on that side of the arch. Having the option to use multiple elastic bands may allow fine-tuning of extrusion and/or distalization forces on different target teeth.

In this example, the distalizer also includes a first dental attachment feature 714a and a second dental attachment feature 714b that may be configured to apply other orthodontic forces on corresponding teeth, as described herein. The distalizer shown in FIG. 7A-7D is just one example—the distalizers described herein may include any number of elastic engagement structures and/or dental attachment engagement features at any of a number of locations. Customization of the quantity and locations of the elastic engagement structures can enable doctors to fine-tune and better control treatment outcomes as the patient’s anatomy responds to a prescribed treatment. Further, forces can be modulated bilaterally and independently according to the patient’s needs and treatment evolution.

As discussed, the corrective force feature of a distalizer may include a dental attachment engagement feature that is configured to engage with a dental attachment bonded to a target tooth. In some cases, the dental attachment engagement feature may be on the inner surface(s) of the distalizers (i.e., facing the target tooth) and protrude toward the crown surface of the target tooth to engage with bonded dental attachment, even when there is an intended gap or offset between the tooth and the inner surface of the distalizer, for example, at an offset region of the distalizer. With a large gap, such as could be needed for unconstrained distalization of a posterior segment of teeth, traditional bonded dental attachments would need to protrude from the tooth crown significantly to engage with a traditional aligner attachment pocket. Having a dental attachment engagement feature that protrudes from the inner surface of the distalizer solves this problem.

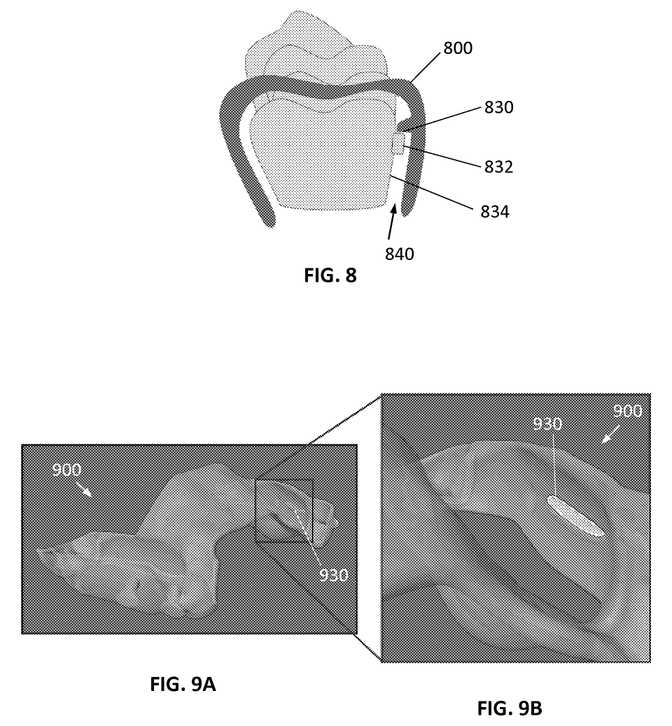

For example, FIG. 8 shows a section view of an example distalizer 800 that includes a dental attachment engagement feature 830 located on an inner surface of the distalizer 800 and that is configured to engage with and apply force on a dental attachment 832 that is bonded to a target tooth 834. The dental attachment engagement feature 830 protrudes from an inner surface of an offset region of the distalizer 800, where the internal walls of the distalizer 800 remain offset with respect to (do not contact) the tooth 834 to provide a gap 840, thereby allowing rapid and unconstrained distalization. That is, the internal walls of the offset region of the distalizer 800 do not contact buccal, lingual or occlusal surfaces of the tooth 834. However, the dental attachment engagement feature 830 protrudes inward to contact the dental attachment 832 and to apply a correction force to the target tooth 834. This design allows engagement between the distalizer 800 and the bonded dental attachment 832 without the need for an excessively large attachment on the crown of the tooth 834, which could be a patient comfort concern when not wearing the distalizer 800.

Since the dental attachment engagement feature 830 protrudes from the internal surface of the distalizer 800, and the distalizer 800 is configured to provide the gap 840 between the distalizer 800 and the tooth, an outer surface of the distalizer 800 can have a smooth surface (e.g., without a corresponding protrusion (e.g., hump)). This can make the distalizer 800 more comfortable for the user to wear and be more aesthetically pleasing.

FIGS. 9A and 9B show another example of a distalizer 900 that includes a dental attachment engagement feature 930 that protrudes from an inner surface of an offset region of the distalizer 900. In this example, the dental attachment engagement feature 930 has a linear (e.g., flat) engagement surface that is configured to interfaces with an active surface of a corresponding dental attachment. The linear (e.g., flat) engagement surface can be optimized to apply tooth movement forces in certain axes during rapid segmental distalization but remain passive in other axes. The forces can be applied even as the teeth move to new positions during distalization treatment.

In some examples, the dental attachment engagement feature can provide non-restraining translation attachment to permit free translational movement of the segment of the teeth along Y-axis while also providing, for example, targeted individual tooth intrusion/extrusion (Z-axis force), root tipping forces (X-axis movement), and/or rotation (Z-axis moment) on individual target teeth.

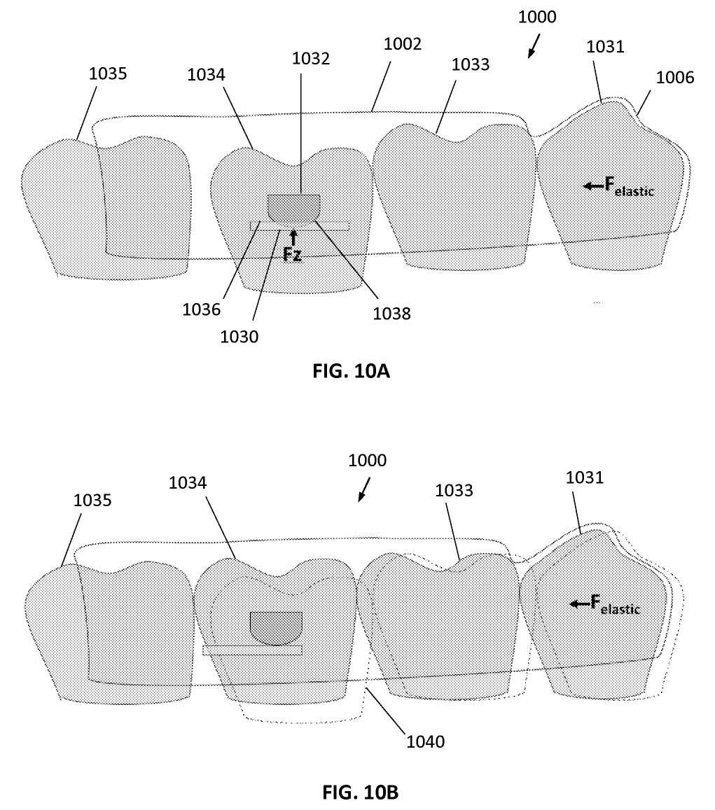

For example, FIGS. 10A and 10B shows another example of distalizer 1000 that includes a dental attachment engagement feature 1030. FIG. 10A shows an outline of the distalizer 1000 over a set of teeth at the beginning of a distalization treatment. A cavity 1006 of the distalizer 1000 is configured to fit over and contact a canine tooth 1031 to provide an elastic distalizing force (F_{elastic}) when an elastic band is engaged with the distalizer 1000. The distalizer 1000 includes an offset region 1002 that has walls that are offset with respect to the surfaces of three of the teeth: first premolar 1033, second premolar 1034, and first molar 1035. A dental attachment engagement feature 1030 protrudes from an inner surface of the offset region 1002 and is configured to engage with and apply an extrusion force (F_{z}) on a dental attachment 1032 that is bonded to the second premolar 1034. The dental attachment 1032 has a geometry (e.g., a curved engagement surface 1038) that provides a targeted single-axis force on the second premolar 1034 while the first premolar 1033 and the second premolar 1034 translate due to the transmitted crown-to-crown forces from the elastic distalizing force (F_{elastic}).

FIG. 10B shows the distalizer 1000 and the teeth after distalization treatment. A dotted line 1040 shows the position of the teeth at the beginning of treatment (FIG. 10A). As shown, the positions of the canine tooth 1031, the first premolar 1033 and the second premolar 1034 have moved distally due to the elastic distalizing force (F_{elastic}). In addition, the second premolar 1034 has moved upward in line with the canine 1031, the first premolar 1033, the second premolar 1034 and the first molar 1035 due to the extrusion force (F_{z}).

As discussed, any of the distalizers described herein can include a transpalatal region that spans the patient’s palate and connects the tooth segment regions of the distalizer. In some examples, the transpalatal region has a varied thickness in one or more axes to improve patient comfort and/or improved durability of the device. In some cases, varied thickness across different axes may be beneficial for the durability of the device. In some cases, the thickness may be varied to provide support when applying forces for simultaneous arch expansion treatment (along with distalization). In some examples, the varied thickness may provide a custom anatomical shape to the transpalatal region (e.g., customized to the patient’s dental arch and treatment needs).

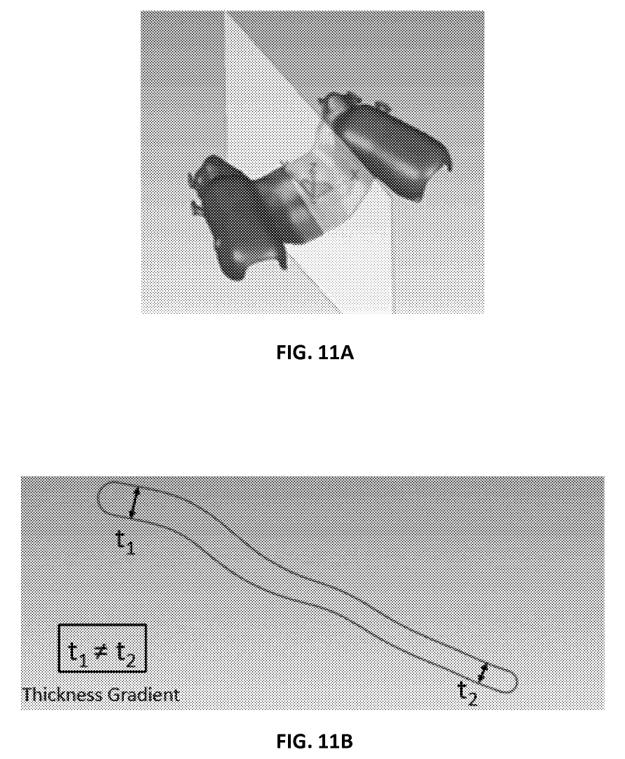

FIGS. 11A and 11B illustrate an example of a distalizer having a transpalatal region with a varied thickness. As shown in FIG. 11B, the thickness of the transpalatal region has a varied thickness in the posterior-anterior axis. In this example, an anterior portion of the transpalatal region has a lesser thickness than the posterior portion. The thinner anterior portion can allow for more clearance for the patient’s tongue and provide better comfort. The thickness gradient along the posterior-anterior axis can have a gradient (e.g., gradual) change so as to avoid abrupt thickness changes. Alternatively or additionally, the thickness of the transpalatal region may vary across the arch (along the buccal-lingual or lateral axis).

As discussed, a treatment plan for a dentition may include a single distalizer appliance (e.g., used during single distalization treatment stage) or multiple distalizer appliances (e.g., used in multiple corresponding distalization treatment stages). In some cases where multiple distalizers are used, the treatment plan may include an ordered series of distalization treatment stages involving the use of an ordered series of distalizer appliances. Each of the series of distalizer appliances may have different features for applying distalization forces and/or other corrective forces according to the corresponding treatment stage. For example, a first distalizer in a series may include an offset region that has an inner surface that is configured to be offset by a first distance with respect the set of posterior teeth, while a second distalizer in the series may include an offset region that is configured to be offset by a second distance with respect the set of posterior teeth, where the first and second distance are different.

The distalizing treatments may be integrated into a full treatment plan in ways that are not conventionally done. For example, distalization of the upper arch (e.g., sagittal correction) is conventionally conducted prior to implementing other tooth movements, leaving the anterior correction of the teeth as a subsequent treatment. As discussed herein, the distalizer itself can include one or more features (e.g., contact regions and/or dental attachment engagement features) that apply forces to the teeth to promote tooth movements other than distalization, thereby integrating distalization with other orthodontic treatment, for example, to correct issues related to anterior crowding. In addition, the distalizers may be paired with appliances that apply corrective forces to teeth of the lower jaw to advance dental correction as distalization treatment progresses. Also, one or more distalizers may be integrated at predetermined segments in the treatment plan.

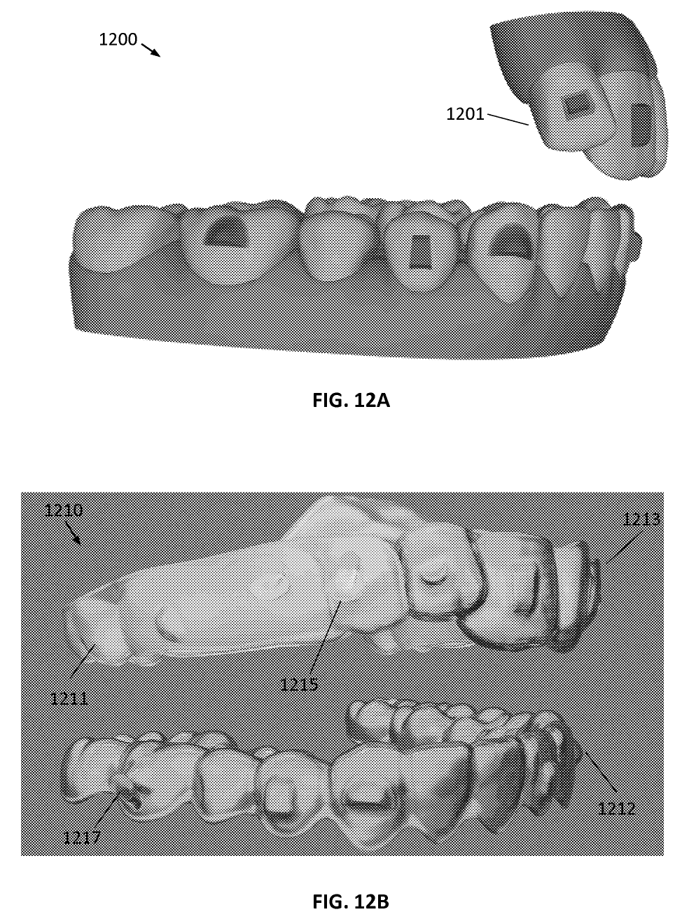

FIG. 12A shows an example digital dental model 1200 according to a treatment plan, showing how upper anterior teeth alignment and/or bottom teeth alignment can be implemented concurrently with distalization in a treatment plan, according to some examples. In this case, the treatment plan software allows the user (e.g., doctor) to modify the upper dental arch by removing at least some of the posterior upper teeth from the digital dental model 1200 such that only includes anterior teeth 1201. This allowed the treatment planning software to remove the posterior upper teeth from consideration for appliance generation in one or more stages of the treatment plan to make alignment corrections to one or more of the anterior teeth 1201 (e.g., incisors, or incisors and canines). For example, the anterior teeth 1201 may need movement correction for anterior crowding. Removing the posterior upper teeth from the digital model 1200 provides a way to digitally plan for and apply alignment forces on the anterior teeth 1201. That is, alignment forces for aligning at least one of the anterior teeth 1201 may be determined (e.g., calculated). This provides the user the option to implement, or plan for, non-distalizing orthodontic appliances during the distalizing process.

FIG. 12B shows an example of a system of dental appliances 1210 for distalization and upper anterior teeth alignment. In this example, the system of dental appliances 1210 includes a first dental appliance 1211, a second dental appliance 1213, and a third dental appliance 1212. The first dental appliance 1211 may correspond to a distalizer appliance that is configured to apply a distalizing force to posterior teeth, as described herein. The second dental appliance 1213 may correspond to a partial aligner (e.g., made of a polymer shell) that is configured to align one or more of the upper anterior teeth (e.g., incisors, or incisors and canines). In some examples, the first upper dental appliance 1211 and the second upper dental appliance 1213 may be configured to be worn on the upper arch at the same time. In some cases, the first upper dental appliance 1211 and the second upper dental appliance 1213 may be worn on the upper arch different times. For example, the patient may wear the first upper dental appliance 1211 during a first period of time (e.g., day or night) and the second upper dental appliance 1213 during a second period of time (e.g., the night or day).

The third dental appliance 1212 may correspond to an aligner (e.g., made of a polymer shell) for the lower dental arch. The third dental appliance 1212 may include one or more second elastic engagement structures (e.g., elastic engagement structure 1217) for engaging with one or more elastic bands that is/are also engaged with one or more first elastic engagement structures (e.g., elastic engagement structure 1215) of the first dental appliance 1211. As discussed herein, the first dental appliance 1211 can apply the distalization force(s) to the upper posterior teeth when the elastic band(s) is/are coupled with corresponding first and second elastic engagement structures (e.g., 1215 and 1217). In some cases, the lower dental appliance 1212 is also configured to apply corrective forces to one or more of the lower teeth to align the one or more lower teeth.

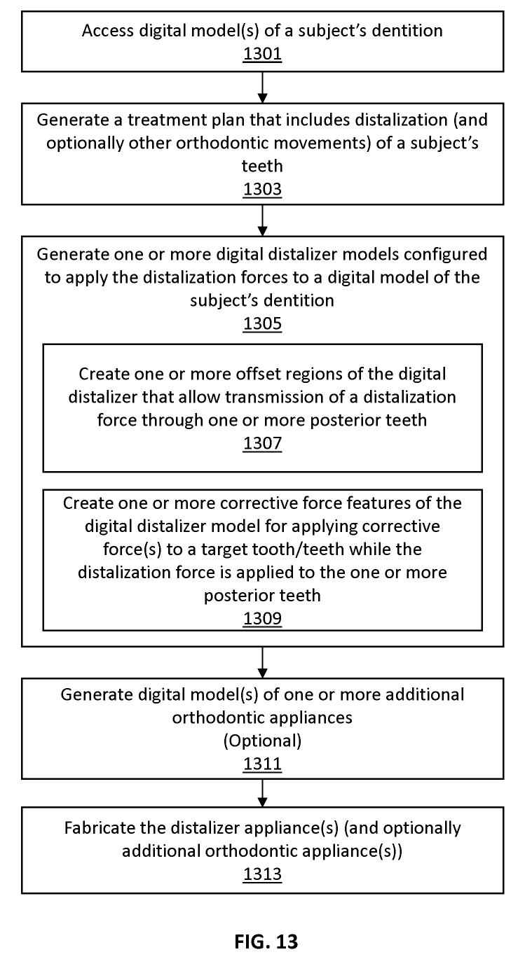

FIG. 13 is a flowchart indicating an example method, e.g., of generating an orthodontic treatment plan, that includes distalization and making (e.g., designing and/or fabricating) any of the distalizer appliances described herein. Some of the methods may include one or more portions that are performed by one or more computers, and may therefore be embodied as a software, such as a non-transitory computer-readable storage medium storing a set of instructions capable of performing the method.

The method can include acceding one or more digital models of a subject’s dentition are accessed (1301). The digital models may include models of the subject’s upper and lower jaws, including a palatal region. The digital models may include an initial dentition model corresponding to the subject’s dentition prior to treatment and a final dentition model corresponding to the subject’s dentition at the end of treatment. The initial dentition model may be generated based on a scan (e.g., collected using an intraoral scanner) of the subject’s oral cavity. The final dentition model may represent the teeth in distalized positions as well as the result of any non-distalizing corrective movements, such as straightening the position of one or more teeth.

A treatment plan that includes distalization of a subject’s teeth can be generated (1303). For example, the treatment planning software may determine tooth movements (e.g., tooth paths) for each tooth to accomplish the final dentition model from the initial dentition model. The treatment planning software may calculate multiple treatment stages to achieve the final dentition model based on the tooth movements (e.g., tooth paths). In some examples, the treatment stages may include one or more distalization stages for distalizing posterior teeth (e.g., molars and premolars) to achieve, for example, sufficient bite alignment of the posterior teeth (e.g., at or near Class I molar and/or canine relationship). In some cases, the treatment plan may be optimized to only include a single distalization stage, e.g., that is configured to be implemented by a single distalizer appliance. In other cases, the treatment plan includes multiple distalization stages, e.g., that are configured to be implemented by multiple corresponding distalizer appliances. The distalization stage(s) may optionally include one or more corrective (e.g., non-distalizing) movements of the teeth (e.g., molar(s) and/or premolar(s)) and/or canine teeth). The treatment stages may also include corrective/alignment stages (e.g., post-distalization) for aligning/straightening the teeth, for example, anterior teeth.

The treatment planning software may be configured to display an interactive user interface that allows a user (e.g., dentist) to choose and modify aspects of the distalization stage(s) and/or other treatment stages of the treatment plan. In some cases, the user interface allows the user to separately design treatment planning for other tooth corrections other than the distalization, such as correction to anterior teeth (e.g., FIG. 12), thereby providing the user flexibility and to plan a comprehensive orthodontic treatment.

One or more digital distalizer models that is/are configured to apply distalization forces to a digital model of the subject’s dentition is/are generated (1305). A digital distalizer model may include first and second tooth segment regions that are configured to fit over and accommodate teeth on opposite sides of the subject’s dentition (e.g., upper jaw). For example, the first tooth segment region may be configured to accommodate a first set of the subject’s maxillary teeth, and the second tooth segment region may be configured to accommodate a second set of the subject’s maxillary teeth on the opposite side of the subject’s upper jaw. Each of the first and second tooth segment regions may be configured to accommodate one or more molars, a canine and/or one or more premolar teeth). The first and second tooth segment regions may be configured to accommodate the same number of teeth or a different number of teeth. One or both of the first and second tooth segment regions can be configured to engage with an elastic band to apply a distalization force along the respective first and/or second segment of teeth.

The distalization force may be determined automatically by the treatment planning software (e.g., based on the final/desired tooth arrangement and/or the treatment plan) and/or set to a target distalization force based on input from a user (e.g. dentist). The distalization force may be predetermined and/or modified by the user.

Generating the digital distalizer model(s) may include creating one or more offset regions of the first and/or second tooth segment regions that allow transmission of a distalization force through one or more (e.g., at least two) posterior teeth of the segment of teeth (1307). The offset region(s) can be configured to accept one or more posterior teeth, wherein the offset region includes an inner surface that is arranged to be offset with respect to one or more posterior teeth such that offset region does not directly contact the one or more posterior teeth to allow the distalization force to transmit through the one or more teeth. Generating the digital distalizer model may also include creating one or more corrective force features of the digital distalizer model for applying corrective force(s) (e.g., translation, tipping, intrusion, extrusion, uprighting and/or torquing) to one or more target teeth of the segment of teeth while the distalization force is applied to the one or more posterior teeth (1309).

Other design considerations for optimizing the digital distalizer model may include determining or adjusting the location(s) of one or more of the elastic engagement structures (e.g., hooks or buttons), which are configured to engage with one or more elastic bands. The distalization force(s) may be estimated or calculated from the position of the elastic engagement structure (s) and the elastic band characteristic(s) (e.g., strength, thickness, length). The elastic engagement structure (s) may be located on the offset region (e.g., exterior buccal surface) of the distalizer appliance. In some cases, the elastic engagement structure (s) is/are located distal to a cavity of the tooth segment region that is configured to accept a canine tooth of the segment of teeth. The tooth segment region may include multiple elastic engagement structures (e.g., located along a buccal side of the tooth segment region). Each elastic engagement structure may be configured to engage with an elastic band, thereby allowing more options as to the force and direction of the distalization force.

The digital distalizer model may include a transpalatal region that is configured to span the subject’s palate and to extend between the first tooth segment region and the second tooth segment region. Dimensions of the transpalatal region may be determined based on a magnitude and/or direction of a counter force provided by the transpalatal region to prevent or limit crown tipping and/or rotation of teeth (e.g., molars and canines) when the distalizer appliance is worn. This may include estimating or calculating the counter force based on the current and/or final tooth positions, the morphology of the subject’s upper and/or lower dentitions, the location(s) of the elastic engagement structure (s), the location(s) and/or shape(s) of the offset region(s), and/or characteristics of the corrective force feature(s).

Digital model(s) of one or more additional orthodontic appliances may optionally be generated (1311). The additional appliance(s) may include, for example, one or more lower appliances for the subject’s lower dentition and/or one or more upper appliances (e.g., aligners) for the subject’s upper dentition. The lower appliance(s) may include elastic engagement structure (s) for engaging with the elastic band(s) that are also engaged with the distalizer appliances. The lower appliance(s) may include partial appliances that are configured to only adjust the anterior teeth (See, e.g., FIG. 12). The additional orthodontic appliance(s) may include a series of aligners for straightening the subject’s teeth, e.g., after distalization.

The distalizer appliance(s), and optionally the additional orthodontic appliance(s), may be fabricated (1313). The digital distalizer model(s), and optionally the digital model(s) of the additional orthodontic appliance(s), may be transmitted to a fabrication device or system (e.g., 3D printer and/or molding apparatus) for fabrication. The fabrication device or system may then fabricate/manufacture the appliances.

### Class III Distalizer Appliances for Direct Fabrication

Any of the distalizers (and methods of making and/or using them) described herein may be configured as Class III Distalizer Appliances for lower arch distalization and Class III bite correction. In general, any of these distalizers, including those configured as Class III distalizer appliances may be made (e.g., fabricated) using a direct printed (DFab) technique. For example, any of these apparatuses (e.g., orthodontic and/or dental appliances) may be configured as patient-specific direct printed (DFab) appliances to correct Class III molar relationships that may also be configured to provide orthodontic tooth movements simultaneously. The geometry of the appliance(s), e.g., tooth hull fillers, region specific offsets, etc. can be customized to apply targeted force systems to the teeth. Further, appliance features, including but not limited to self-supported buttons (e.g., elastic connectors, bars, etc.), arch connection, etc., can be customized for patient specific anatomy, and treatment response/progression.

As described herein, additional advantages of these apparatuses may include, but are not limited to: removablity, minimize tooth contact, limit canine extrusion,

For example, any of these appliance may be configured to be applied/removed by the subject wearing them (e.g., may be removable), avoiding continuous visits to doctors due to debonding of fixed appliances that are designed for similar corrections. In addition, these apparatuses may be configured as class III distalizers having a single connected lower arch appliance that avoids the anterior teeth (may include one or more anterior cutout). This may promote unconstrained distalization of the posterior teeth without incisal restrictions or unwanted incisal tooth movements. The tooth hull fillers provide a flat occlusal surface that can function as a bite deprogrammer, potentially promoting a faster bite class correction. The tooth hull fillers and targeted crown offsets described herein may promote biomechanically faster distalization by allowing crown to crown contact of the posterior teeth. This may also or alternatively promote faster bite class correction. Any of these methods and apparatuses may include one or more canine bite ramps and tooth hull fillers that may serve as a counter measure for canine extrusion commonly seen with the use of heavy elastics for bite correction. These apparatuses many be wrapped and/or may include selective additive material that may allow canine and molar mesial tipping control. Any or all of these features and advantages may also apply to a Class II distalizer appliance for the maxillary arch and are not limited to a Class III appliance.

### Lip Bumper

Any of these apparatuses may include a lip bumper. For example, a Class III Distalizer may include a lip bumper. The apparatus including the lip bumper may be fabricated by direct fabrication. The removable device may include a customizable posterior teeth appliance that wraps the canine, premolar, and molar teeth of the patient through a hull filler geometry that functions as an occlusal deprogrammer and force transmitter for distalizing mechanics.

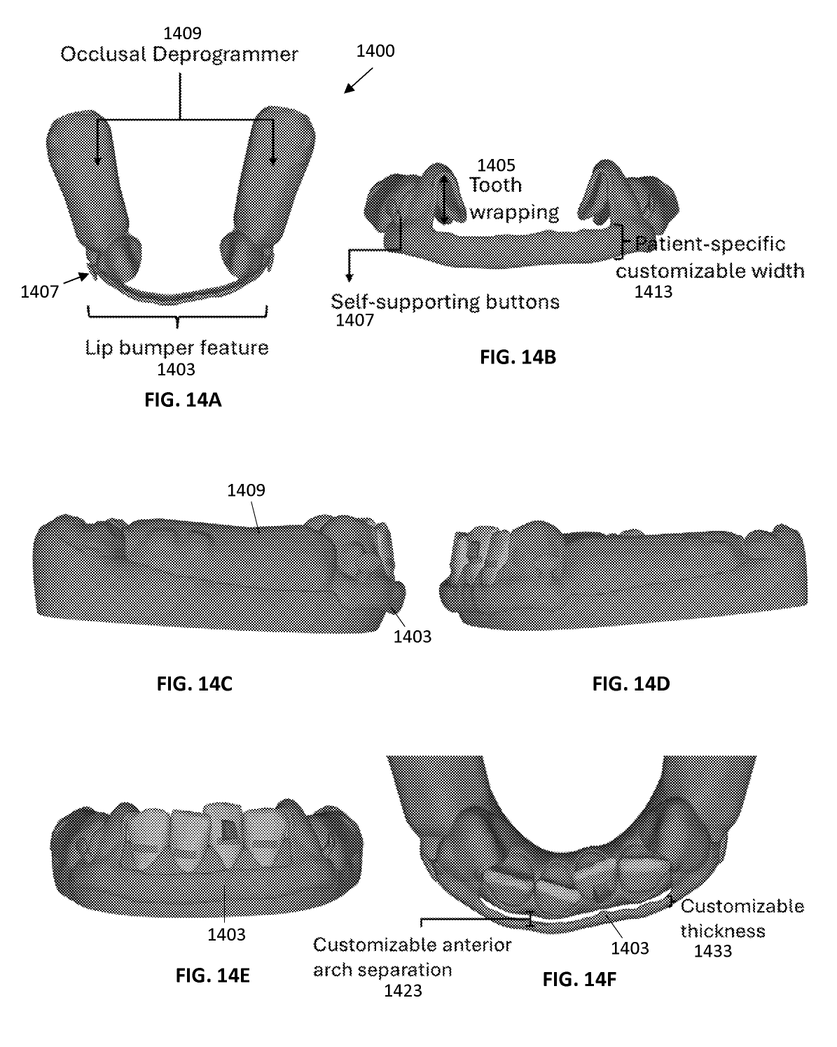

In any of these appliances, the right and left side may be connected through a buccal lip bumper feature that can provide additional distalization force from the patient’s bottom lip and prevents choking risks. This is illustrated in FIGS. 14A-14F. The width, thickness, and separation from the anterior teeth of the lip bumper can be customized to accommodate patient anatomy, device stiffness, and treatment progression.

In any of these methods described herein, the apparatus may be designed for use with a particular subject (e.g., customized) using software that models the subject’s teeth and/or may incorporate a treatment plan. The apparatus may be adjusted, e.g., by a user such as a dentist, orthodontist, and/or technician, and modifications to include any of these features may be manually, automatically and/or semi-automatically made to a digital model of the appliance, or a series of appliances. Modifications may simulated to determine teeth movements and/or retention, and/or fit, intercuspation, etc. These apparatuses may be iteratively designed, allowing multiple changes that may propagate the modification through the treatment plan.

Any of these appliances may include self-supported buttons for the engagement of elastics for class III bite correction. These buttons may be integrated (and fabricated by direct fab) as part of the overall appliance. Alternatively, these structures may be separately fabricated (including by a direct fabrication technique) and added/combined with the rest of the appliance. Any of these appliances may include a customizable tooth wrapping parameter to enhance force transmission and appliance retention.

FIGS. 14A-14F illustrate one example of an appliance, configured as a Class III distalizer appliance 1400, including a lip bumper 1403, two self-supporting buttons 1407 and an offset region (configured as an occlusal deprogrammer) posterior to an anterior tooth engagement region, in this example, configured to contain a canine. The width/height of the lip bumper region 1403 may be customized to the patient 1413 (FIG. 14B) as may be the anterior arch separation 1423 and/or the thickness 1433, as shown in FIG. 14F. The bumper region may connect the left and right sides of the apparatus while forming a window that minimizes contact with the anterior teeth (e.g., the incisors in FIGS. 14A-14F).

### Class III Distalizer with lingual strip connection

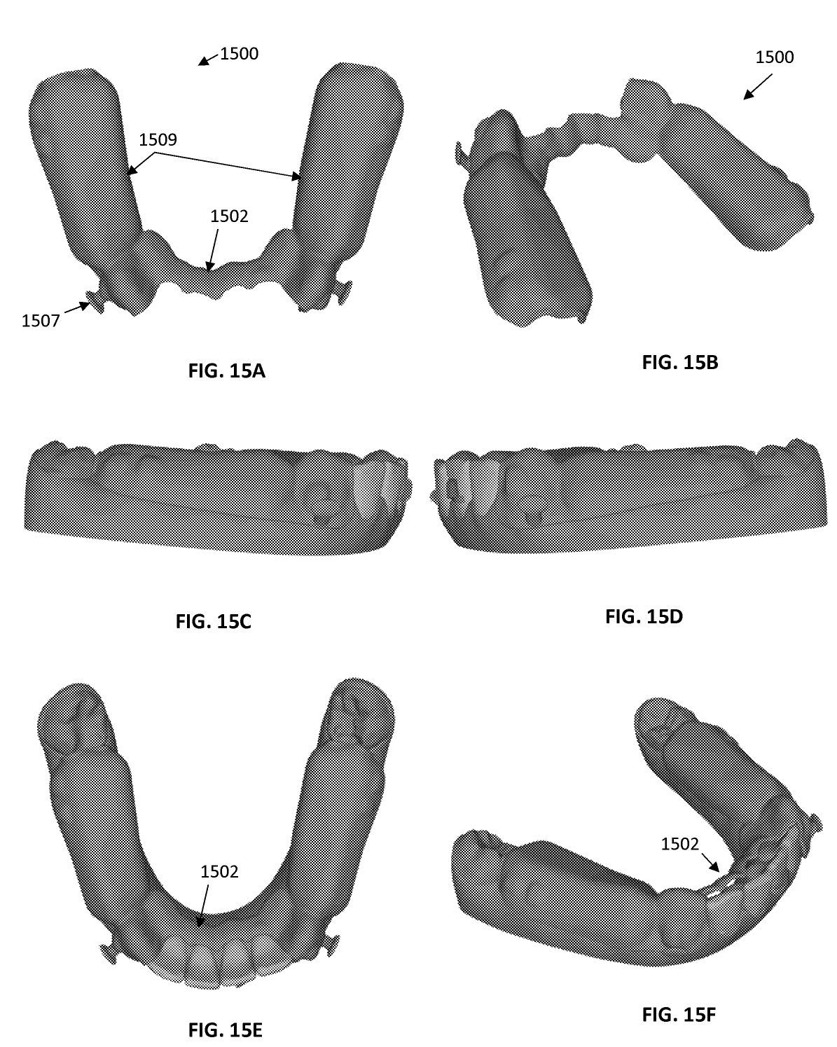

Any of these apparatuses may include a lingual strip connection instead of, or in addition to, a lip bumper. The lip bumper typically passes (and is offset from) the buccal surface of the teeth (and/or in some examples, gingiva), and the lingual strip may extend behind (and be offset from) the lingual surface of the teeth and/or gingiva. FIGS. 15A-15F illustrate an example of an appliance 1500 configured as a Class III distalizer with includes a lingual strip connector/connection 1502. This example also includes a pair of buttons 1507 as well as an occlusal deprogrammer region 1509.

These Class III distalizers including a lingual strip may be a customizable, as described above, and may be fabricated by direct fabrication to form the removable appliance. In this example, the posterior teeth may provide distalization forces to promote Class III bite corrections. In this example, the appliance wraps around the posterior teeth through a hull filler feature that can also serve as a bite deprogrammer 1509 and transmitter for distalizing mechanics.

The right and left sides of the appliance may be connected through the lingual strip 1502 to avoid choking hazards to patients and may provide rigidity to accommodate distalization forces. This feature can be customizable in width, thickness, and separation from the anterior teeth to accommodate patient anatomy, device stiffness, and treatment progression.

As discussed above, any of these apparatuses may be formed by a user (technician, doctor, etc.) using software to incorporate and/or modify features forming the distalizer. These methods may include receiving, importing, accessing and/or generating a 3D model of the subject’s dentition and/or a treatment plan. In some cases, the user may manipulate a 3D (digital) model of the teeth and/or of one or more appliances configured to confirm to the teeth. The user may add/remove any of the features described herein, and/or modify any of these features. For example, the method or apparatus (e.g., software) may generate a distalizer and/or may allow the user to modify a distalizer.

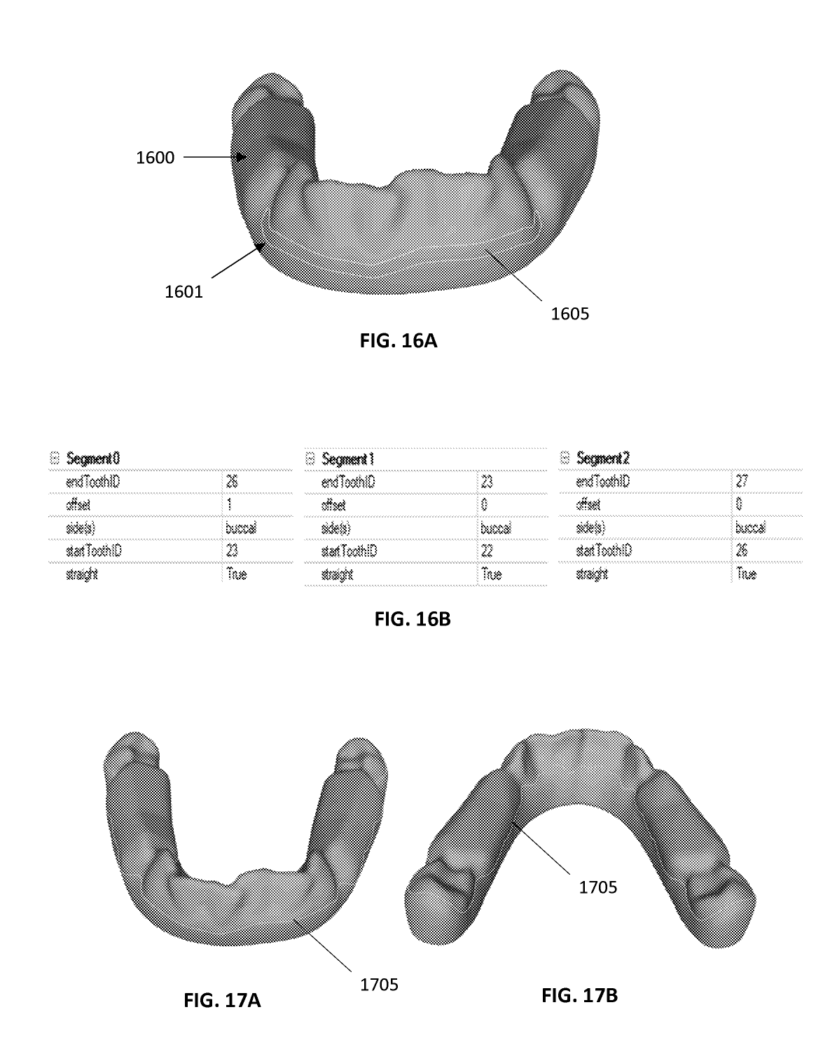

In some cases the user may generate and/or modify a boundary of a distalizer. For example, the boundary of a distalizer may be generated with command modifications, which define surface regions and apply Boolean operations on the mold surface. FIG. 16A illustrates one example of a mold surface 1600 of a subject’s lower jaw (not shown) that may be used to generate a distalizer. In this example the line 1601 (which may be shown in a color, e.g., green) is a line forming a closed contour that defines a region 1605 on the mold surface.

In some example the apparatus (e.g., system) for designing and/or modifying the distalizer may perform modifications (e.g., a list of segment modifications) to form the distalizer, including by applying a straight cut (to buccal side between T22 and T27) and may adjust the offset of boundary segments as described above. These modifications may be textual or may be input by selecting regions (e.g., moving a mouse, cursor, etc.) on the 3D model. Examples of these cuts/commands are shown in the table of FIG. 16B. The table of FIG. 16B shows directions specifying the segments of the region forming part of the boundary of a distalizer. These segment modifications form an initial boundary. FIGS. 17A-17B illustrate another example of a specified boundary of a distalizer, e.g., cutting away portions of the mold surface formed over the model of the teeth. FIG. 17A shows the image from the front, and FIG. 17B shows the mold surface from the back; the specified line 1705 is shown on the surface.

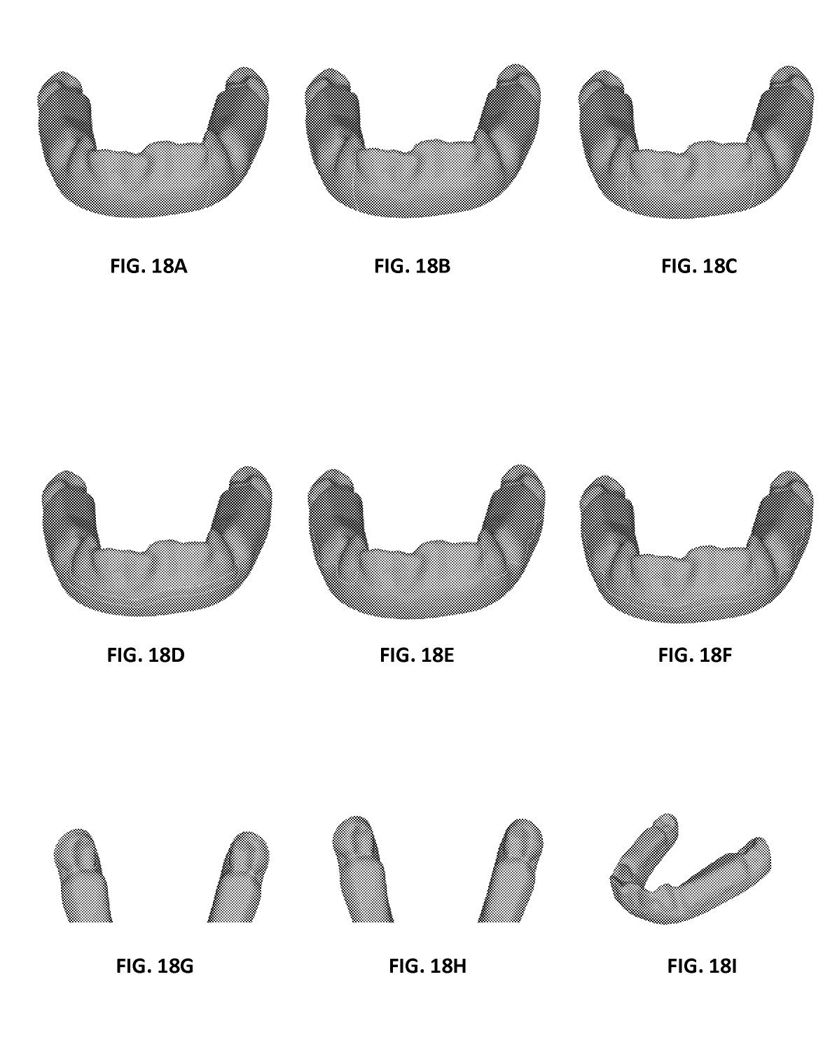

Examples of commands applied to the initial boundary to generate a distalizer boundary are illustrated in FIGS. 18A-18I. For example FIG. 18A illustrates an initial command (CreateMoldRegion -p:name=ipline_22_23 -p:region=ipline(22,23) -p:frame=0 -p:jaw=l) that to create an interproximal (IP) line between T22 and T23, as shown. Next, (command 2: CreateMoldRegion -p:name=ipline_26_27 -p:region=ipline(26,27) -p:frame=0 -p:jaw=l) an IP line is generated between T26 and T27, as shown in FIG. 18B. FIG. 18C shows the defining of a region bounded by the two IP lines (command 3: SubtractFromMoldRegion -p:name=ipline_26_27 -p:region=ipline_22_23 -p:frame=0 -p:jaw=l). FIG. 18D shows a strip region between T22 and T27 is then created (command 4: CreateBoundaryEnvelope -p:name=envelope_22_27 -p:bandSize=2 -p:side=buccal -p:teeth=22-27 -p:frame=0 -p:jaw=l; in this example, “bandSize” controls the width of the strip). FIG. 18E shows subtracting the IP region (from Command 3) from the initial boundary (command 5: SubtractFromBoundary -p:region=ipline_26_27 -p:frame=0 -p:jaw=l). The strip region (from Command 4) may be added to the boundary (from Command 5) (e.g., command 6: AddToBoundary -p:region=envelope_22_27 -p:frame=0 -p:jaw=l), as shown in FIG. 18F. In FIG. 18G, the tooth regions for T18 and T31 are created (command 7: CreateMoldRegion -p:name=teeth_18_31 -p:region=teeth(18,31) -p:frame=0 -p:jaw=l). In FIG. 18H, T18 and T31 regions (from Command 7) are subtracted from the boundary (command 8: SubtractFromBoundary -p:region=teeth_18_31 -p:frame=0 -p:jaw=l). FIG. 18I shows the final boundary lines.

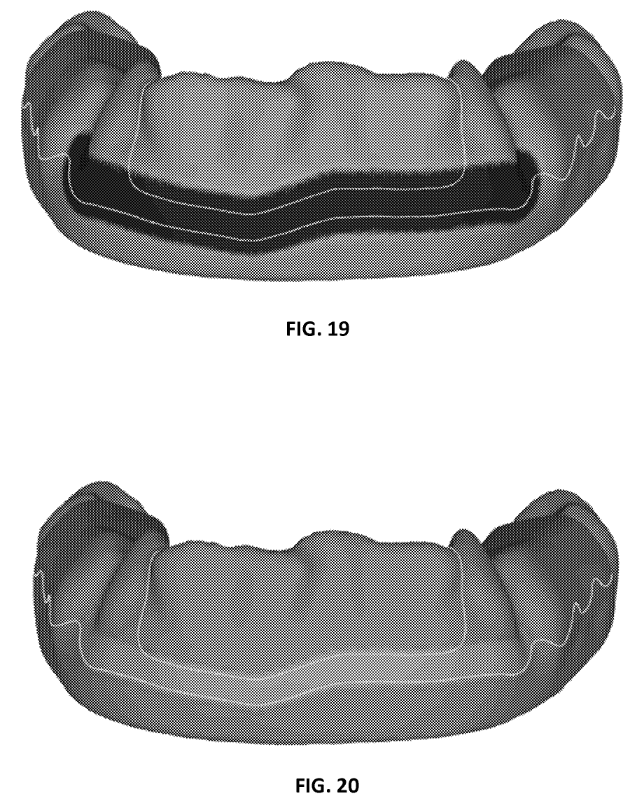

To control the anterior arch separation, the distance between the inner surface of the strip region to gingiva may be controlled, which can be adjusted by modifying the offset of the strip region, e.g., using a command (e.g., command: ApplyOffset -p:amount=1 -p:region=envelope_22_27 -p:fade=1 -p:frame=0 -p:jaw=l), which may adjust the offset of the strip region (generated by Command 4). The distance can be controlled by the parameter “amount”, as shown in FIG. 19.

Similarly, the thickness of the strip can be adjusted by modifying the thickness of the strip region, as shown in FIG. 20, (e.g., with a command: command: ApplyThickness -p:amount=1.2 -p:region=envelope_22_27 -p:fade=1 -p:frame=0 -p:jaw=l). This may adjust the thickness of the strip region (generated by Command 4) by setting “amount” value.

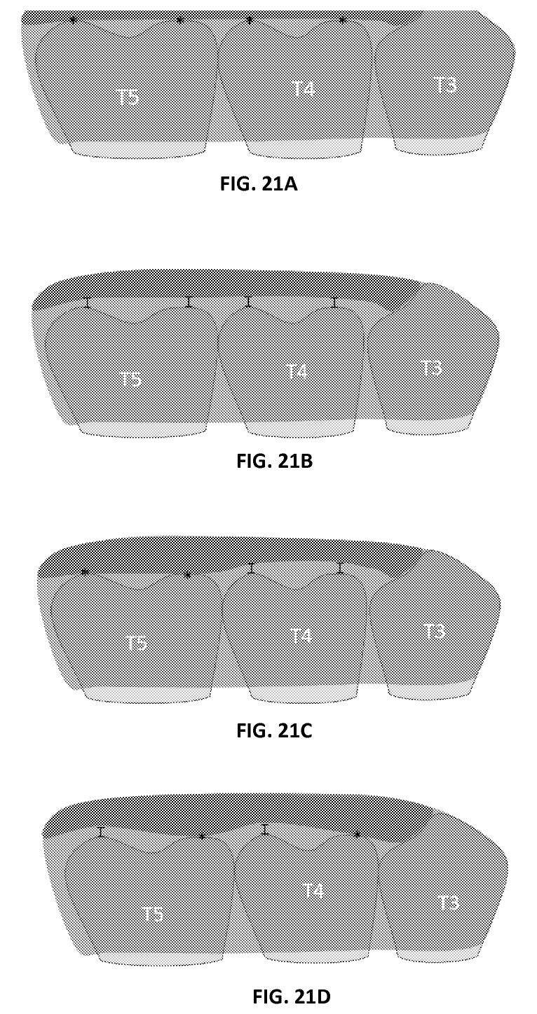

Any of these appliances (distalizers) may include an internal cusp-matching occlusal planar feature, such as an internal feature within the offset segment that includes selective occlusal matching for cusp-matching and/or cusp-clearance on individual target teeth. This feature may be a modification of the thickness of the occlusal surface of the distalizer appliance and can be used for targeted z-control and/or x-moment of individual teeth and/or individual cusps within the offset segment. By individually targeting these cusp contacts, varying treatment outcomes can be achieved without the need for additional bonded attachments to the teeth. These treatment outcomes may include: full cusp contact (FIG. 21A); full cusp clearance (FIG. 21B); selective cusp contact (e.g., intrusion/extrusion) (FIG. 21C); and/or selective cusp contact (e.g., M/D root control) (FIG. 21D). In FIGS. 21A-21D the cusp contact is shown by the asterisk, while cusp clearance (spacing) is shown by the bracket.

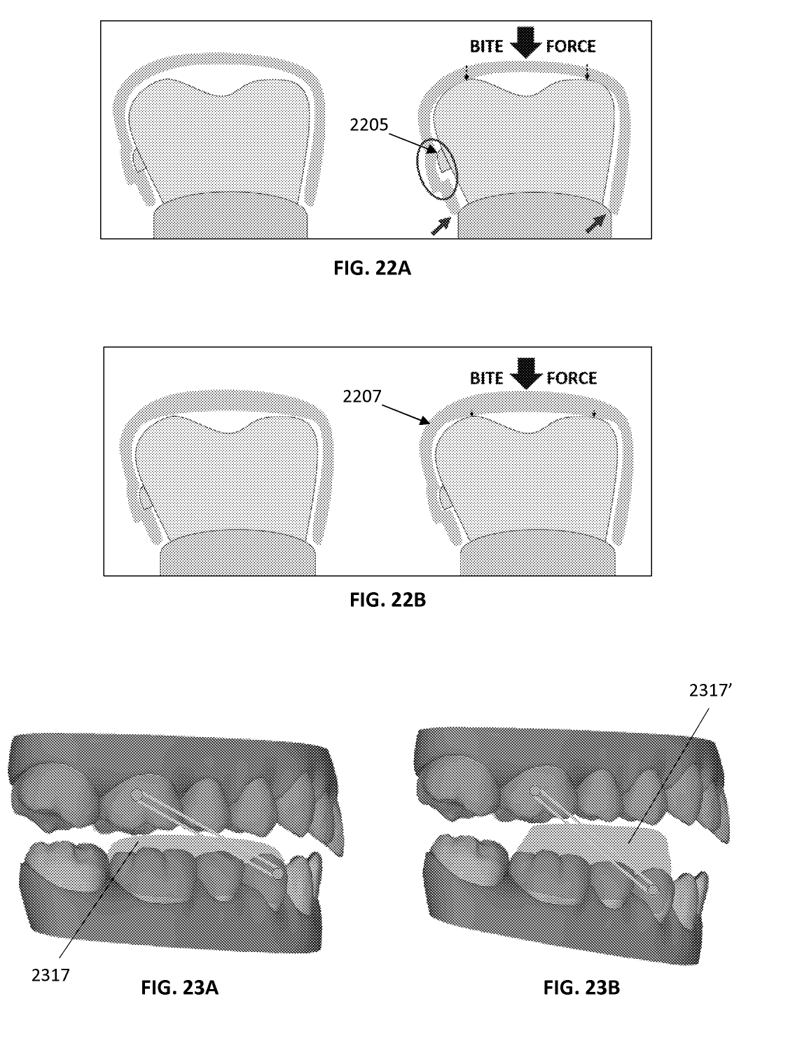

Additionally, increased appliance thickness on the occlusal face, including when used in combination with cusp matching, may improve durability, retention, and comfort of the appliance when worn by the patient. The feature may serve as a “stopping” point for the patient during biting to avoid displacement of the appliance in the gingival direction. This displacement, if significant, as shown in FIGS. 22A (compared to 22B), could lead to disengagement of attachments, gingival impingement, and deformation due to the appliance being displaced in the gingival direction. For example, FIG. 22A shows an appliance without cusp-matching occlusal thickness and FIG. 22B show an appliance with cusp-matching occlusal thickness. As shown in FIG. 22A a bite force on the occlusal surface may result in movement of the sides of the appliance away from the attachment 2205. In contrast, by including either cusp matching (not shown) or a hinged region, formed by a reduction in thickness 2207 between the occlusal side and either or both the lingual and/or buccal sides (and the region between the two), as shown in FIG. 22B. This may be particularly helpful in forming the offset region (or in some cases, the occlusal deprogrammer region).

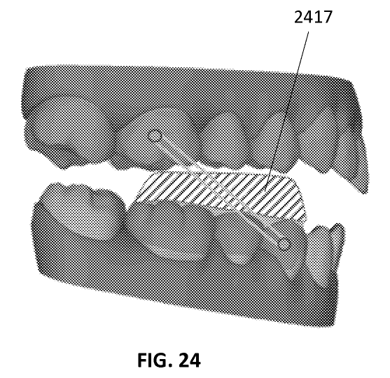

Increasing the thickness of the occlusal region, counterintuitively even in the offset region/occlusal deprogrammer region, may improve the anterior collision avoidance (e.g., anterior collision avoidance through varied occlusal thickness.). For example, for patients with deep bites, anterior collisions may be a concern during treatment as the patient moves his/her jaw in the anterior-posterior direction during speech or sleep. By varying the thickness of the occlusal aspect of the distalizer appliance, the bite may be opened to provide additional clearance between the upper and lower incisors while also acting as a bite deprogrammer as mentioned above. This is illustrated in FIGS. 23A-23B and 24. In these examples, the occlusal regions 2317, 2317’, 2417 of the distalizers shown may have different heights (and/or thickness); in FIG. 23B the height of the distalizer occlusal region is greater than the height of appliance shown in the distalizer of FIG. 23A. For example, the height may be approximately 0.5x or greater than the height of the buccal and/or lingual sides (where height is measured in the z dimension). In some cases the height may be between 0.5x and 1.5x the height of the buccal and/or lingual sides (e.g., approximately the height of the underlying teeth above the gingiva). Note that the height of the occlusal side may be equivalent to the thickness of the occlusal side (but the height of the buccal and lingual sides are not equivalent to their thicknesses).

The additional thickness of the occlusal aspect of the appliance can be achieved through thicker material, or as a hollow feature or a predominantly hollow feature with internal ribs or other support elements as needed to balance strength with material reduction (e.g., for cost savings and/or reduction in weight), as shown in FIG. 24. This thickness parameter may be varied throughout orthodontic treatment, with different stages of the same treatment exhibiting different overall thickness/height amounts as anterior teeth are intruded or posterior teeth are extruded to level the bite during treatment.

Any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control perform any of the steps, including but not limited to: displaying, communicating with the user, analyzing, modifying parameters (including timing, frequency, intensity, etc.), determining, alerting, or the like. For example, any of the methods described herein may be performed, at least in part, by an apparatus including one or more processors having a memory storing a non-transitory computer-readable storage medium storing a set of instructions for the processes(s) of the method.

While various embodiments have been described and/or illustrated herein in the context of fully functional computing systems, one or more of these example embodiments may be distributed as a program product in a variety of forms, regardless of the particular type of computer-readable media used to actually carry out the distribution. The embodiments disclosed herein may also be implemented using software modules that perform certain tasks. These software modules may include script, batch, or other executable files that may be stored on a computer-readable storage medium or in a computing system. In some embodiments, these software modules may configure a computing system to perform one or more of the example embodiments disclosed herein.

As described herein, the computing devices and systems described and/or illustrated herein broadly represent any type or form of computing device or system capable of executing computer-readable instructions, such as those contained within the modules described herein. In their most basic configuration, these computing device(s) may each comprise at least one memory device and at least one physical processor.

The term “memory” or “memory device,” as used herein, generally represents any type or form of volatile or non-volatile storage device or medium capable of storing data and/or computer-readable instructions. In one example, a memory device may store, load, and/or maintain one or more of the modules described herein. Examples of memory devices comprise, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In addition, the term “processor” or “physical processor,” as used herein, generally refers to any type or form of hardware-implemented processing unit capable of interpreting and/or executing computer-readable instructions. In one example, a physical processor may access and/or modify one or more modules stored in the above-described memory device. Examples of physical processors comprise, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the method steps described and/or illustrated herein may represent portions of a single application. In addition, in some embodiments one or more of these steps may represent or correspond to one or more software applications or programs that, when executed by a computing device, may cause the computing device to perform one or more tasks, such as the method step.

In addition, one or more of the devices described herein may transform data, physical devices, and/or representations of physical devices from one form to another. Additionally or alternatively, one or more of the modules recited herein may transform a processor, volatile memory, non-volatile memory, and/or any other portion of a physical computing device from one form of computing device to another form of computing device by executing on the computing device, storing data on the computing device, and/or otherwise interacting with the computing device.

The term “computer-readable medium,” as used herein, generally refers to any form of device, carrier, or medium capable of storing or carrying computer-readable instructions. Examples of computer-readable media comprise, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

A person of ordinary skill in the art will recognize that any process or method disclosed herein can be modified in many ways. The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed.

The various exemplary methods described and/or illustrated herein may also omit one or more of the steps described or illustrated herein or comprise additional steps in addition to those disclosed. Further, a step of any method as disclosed herein can be combined with any one or more steps of any other method as disclosed herein.

The processor as described herein can be configured to perform one or more steps of any method disclosed herein. Alternatively or in combination, the processor can be configured to combine one or more steps of one or more methods as disclosed herein.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the invention. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present invention.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and methods described herein should be understood to be inclusive, but all or a sub-set of the components and/or steps may alternatively be exclusive and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/- 0.1% of the stated value (or range of values), +/- 1% of the stated value (or range of values), +/- 2% of the stated value (or range of values), +/- 5% of the stated value (or range of values), +/- 10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims.

The examples and illustrations included herein show, by way of illustration and not of limitation, specific embodiments in which the subject matter may be practiced. As mentioned, other embodiments may be utilized and derived there from, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

The present disclosure contains the following clauses:

Clause 1: A dental appliance, comprising: a tooth receiving portion shaped to receive a plurality of teeth, the tooth receiving portion comprising an elastic engagement structure arranged to engage with an elastic band to apply a distalization force along the plurality of teeth, wherein the tooth receiving portion comprises: a first contact region that is shaped to contact one or more first teeth of the plurality of teeth; a second contact region that is shaped to contact one or more second teeth of the plurality of teeth; and an offset region that is arranged to receive one or more intermediate teeth of the plurality of teeth, the one or more intermediate teeth positioned between the one or more first teeth and the one or more second teeth, wherein an inner surface of the offset region is shaped to be offset with respect to the one or more intermediate teeth such that the inner surface of the offset region does not contact the one or more intermediate teeth to allow the distalization force to transmit through the one or more intermediate teeth.

Clause 2: The dental appliance of clause 1, wherein the dental appliance further comprises a transpalatal region that connects the tooth receiving portion to a second tooth receiving portion and is arranged to span a palate of a dental arch, wherein the transpalatal region has an anterior edge that is anterior to a premolar region of the tooth receiving portion.

Clause 3: The dental appliance of clause 1, wherein the second contact region is shaped to directly contact the one or more second teeth or indirectly contact the one or more second teeth via one or more dental attachments attached to the one or more second teeth.

Clause 4: The dental appliance of clause 1, wherein a distance between opposite inner surfaces on a buccal side and a lingual side of the offset region is greater than a distance between opposite inner surfaces of the first contact region and the second contact region.

Clause 5: The dental appliance of clause 1, wherein a height of the occlusal surface of the offset region is greater than a height of the occlusal surface of the first contact region and the second contact region.

Clause 6: The dental appliance of clause 1, wherein the second contact region is configured to apply a corrective force on the one or more second teeth, the corrective force applied in a different direction than the distalization force.

Clause 7: The dental appliance of clause 4, wherein the corrective force is a translation, tipping, intrusion, extrusion, uprighting or torquing force applied to the one or more second teeth.

Clause 8: The dental appliance of clause 1, wherein the inner surface of the offset region comprises one or more corrective force features that is configured to engage with one or more corresponding dental attachments attached to the one or more intermediate teeth and apply one or more corrective forces on the one or more intermediate teeth.

Clause 9: The dental appliance of clause 8, wherein the one or more corrective force features protrudes from the inner surface of the offset region to maintain the offset between the inner surface of the offset region and the one or more intermediate teeth.

Clause 10: The dental appliance of clause 1, wherein the one or more intermediate teeth includes a first premolar and/or a second premolar of the plurality of teeth.

Clause 11: The dental appliance of clause 1, wherein the second contact region is configured to contact a buccal surface, a lingual surface or a buccal and lingual surface of the one or more second teeth.

Clause 12: The dental appliance of clause 1, wherein the second contact region includes a lingual wall and a buccal wall that encompass the one or more second teeth, wherein at least one of the lingual and buccal walls contact the one or more second teeth.

Clause 13: The dental appliance of clause 1, wherein the tooth receiving portion includes an elastic engagement structure that is configured to engage with the elastic band, wherein the elastic engagement structure is located on a buccal side of the offset region.

Clause 14: The dental appliance of clause 12, wherein the elastic engagement structure is located distal to a cavity of the tooth receiving portion that is configured to accept a canine tooth of the plurality of teeth.

Clause 15: The dental appliance of clause 11, wherein the elastic engagement structure is located distal to a cavity of the tooth receiving portion that is configured to accept a premolar tooth of the plurality of teeth.

Clause 16: The dental appliance of clause 1, wherein the tooth receiving portion includes multiple elastic engagement structures located along a buccal side of the tooth receiving portion, wherein each of the multiple elastic engagement structures is configured to engage with the elastic band.

Clause 17: The dental appliance of clause 16, wherein the dental appliance is configured to apply the distalization force when two or more elastic bands are coupled with corresponding two or more of the multiple elastic engagement structures at the same time.

Clause 18: The dental appliance of clause 1, wherein the tooth receiving portion is a first tooth receiving portion that is shaped to accept a first plurality of teeth on a first side of a dental arch, wherein the dental appliance further comprises: a second tooth receiving portion that is shaped to accept a second plurality of teeth on a second side of the dental arch; and a transpalatal region that is coupled with the first and second tooth receiving portions.

Clause 19: The dental appliance of clause 18, wherein the transpalatal region has a varied thickness along a buccal-lingual axis and/or a posterior-anterior axis.

Clause 20: The dental appliance of clause 1, wherein the offset region includes an occlusal cutout that is arranged to expose occlusal surfaces of the one or more intermediate teeth.

Clause 21: A method of distalizing a subject’s teeth, the method comprising: applying a dental appliance over a subject’s upper dental arch such that a plurality of teeth of the subject’s upper dental arch are received in a tooth receiving portion of the dental appliance, wherein the tooth receiving portion contacts one or more first teeth of the plurality of teeth and one or more second teeth of the plurality of teeth, wherein an offset region of the tooth receiving portion includes an inner surface that is offset with respect to one or more intermediate teeth between the one or more first and second teeth; and coupling an elastic band to an attachment site on the dental appliance and to an attachment site on the subject’s lower jaw to apply a distalization force that is transmitted through one or more intermediate teeth of the subject’s upper dental arch.

Clause 22: The method of clause 21, wherein the tooth receiving portion applies a corrective force to a target tooth of the one or more second teeth.

Clause 23: The method of clause 22, wherein applying the corrective force includes applying a translation, tipping, intrusion, extrusion, uprighting and/or torquing force to the target tooth.

Clause 24: The method of clause 22, wherein applying the corrective force includes applying the corrective force directly to the target tooth or indirectly to the target tooth via a dental attachment attached to the target tooth.

Clause 25: The method of clause 21, wherein the offset region includes a dental attachment engagement feature that engage with a dental attachment attached to a target tooth of the one or more intermediate teeth to apply a corrective force to the target tooth, wherein the dental attachment engagement feature protrudes from the inner surface of the offset region to maintain the offset between the inner surface of the offset region and the one or more intermediate teeth.

Clause 26: The method of clause 21, further comprising applying a lower jaw appliance on the subject’s lower jaw, wherein coupling the elastic band to an attachment site on the subject’s lower jaw comprises coupling the elastic band to an elastic engagement structure of the lower jaw appliance.

Clause 27: The method of clause 21, wherein coupling the elastic band to an attachment site on the subject’s lower jaw comprises coupling the elastic band to a Temporary Anchorage Device (TAD) in the subject’s lower jaw.

Clause 28: A dental appliance, comprising: a tooth receiving portion shaped to receive a plurality of teeth, the tooth receiving portion comprising an elastic engagement structure arranged to engage with an elastic band to apply a distalization force along the plurality of teeth, wherein the tooth receiving portion comprises: an offset region that is arranged to receive one or more teeth of the plurality of teeth that are to be distalized, wherein an inner surface of the offset region is shaped to be offset with respect to the one or more teeth such that the inner surface of the offset region does not contact the one or more teeth to allow the distalization force to transmit through the one or more teeth; and a dental attachment engagement feature that protrudes from the inner surface of the offset region and is arranged to engage with a dental attachment bonded to a target tooth of the one or more teeth to apply a corrective force on the target tooth, wherein the corrective force is in a different direction than the distalization force.

Clause 29: The dental appliance of clause 28, wherein the tooth receiving portion further comprises: a first contact region that is shaped to contact one or more first teeth of the plurality of teeth; and a second contact region that is shaped to contact one or more second teeth of the plurality teeth, wherein the offset region is arranged to accept one or more intermediate teeth of the plurality of teeth, the one or more intermediate teeth positioned between the one or more first teeth and the one or more second teeth.

Clause 30: The dental appliance of clause 29, wherein the second contact region includes a second dental attachment engagement feature that is configured to contact a dental attachment bonded to a second tooth of the one or more second teeth.

Clause 31: The dental appliance of clause 30, wherein the second dental attachment engagement feature that is configured to anchor the tooth receiving portion to a dental arch.

Clause 32: The dental appliance of clause 30, wherein the second dental attachment engagement feature is arranged to apply a second corrective force to the second tooth.

Clause 33: A method, the method comprising: accessing a digital dentition model of a subject’s dentition prior to a dental treatment plan or at an intermediate stage of the dental treatment plan, wherein the digital dentition model includes an upper dental arch and a lower dental arch, wherein the upper dental arch includes posterior teeth and anterior teeth, wherein the one or more of the posterior teeth are subject to distalization according to the dental treatment plan; modifying the upper dental arch by removing the posterior teeth from the digital dentition model; presenting the upper dental arch with the anterior teeth and without the posterior teeth; determining alignment forces for aligning at least one anterior tooth of the anterior teeth, wherein the posterior teeth are not considered when determining the alignment forces for moving the at least one anterior tooth; generating one or more removable partial anterior appliances for applying the alignment forces to the at least one anterior tooth according to one or more treatment stages of the dental treatment plan; and generating one or more removable distalization appliances for implementing the distalization to the upper dental arch according to the one or more treatment stages of the dental treatment plan, wherein each of the one or more removable distalization appliances includes a tooth receiving portion shaped to receive the posterior teeth and to apply a distalization force on the one or more of the posterior teeth.

Clause 34: The method of clause 33, further comprising determining second alignment forces for aligning at least one lower tooth of the lower dental arch according to the one or more stages of the treatment plan.

Clause 35: The method of clause 34, further comprising generating one or more removable lower dental arch appliances for applying the second alignment forces to the at least one lower tooth.

Clause 36: The method of clause 33, wherein the one or more treatment stages includes at least partial simultaneous application of alignment forces on the at least one anterior tooth of the one or more anterior teeth of the upper dental arch and application of the distalization force on the one or more of the posterior teeth of the upper dental arch.

Clause 37: The method of clause 33, wherein aligning the at least one anterior tooth of the anterior teeth includes correcting crowding of the anterior teeth.

Clause 38: The method of clause 33, wherein at least one of the removable partial anterior appliances is configured to be worn on the upper dental arch as the same time as at least one of the removable distalization appliances.

Clause 39: The method of clause 33, further comprising determining one or more distalization stages for distalizing the one or more posterior teeth.

Clause 40: The method of clause 39, wherein the one or more distalization treatment stages includes an ordered series of distalization treatment stages involving the use of an ordered series of dental appliances, each of the series of dental appliances having a corresponding offset region having an inner surface that is arranged to be offset by a different distance with respect to at least two teeth of the one or more posterior teeth.

Clause 41: A dental appliance system, comprising: a first dental appliance shaped to receive a plurality of posterior teeth of an upper dental arch wherein the first dental appliance includes a first elastic engagement structure that is arranged to engage with an elastic band; Clause a second dental appliance shaped to receive one or more anterior teeth of the upper dental arch, the second dental appliance configured to apply alignment forces on at least one anterior tooth of the one or more anterior teeth; and a third dental appliance shaped to receive one or more teeth of a lower dental arch, the third dental appliance including a second elastic engagement structure that is arranged to engage with the elastic band, wherein the first dental appliance is configured to apply a distalization force along the plurality of posterior teeth of the upper dental arch when first and third dental appliance are worn and the elastic band is engaged with the first and second elastic engagement structures.

Clause 42: The dental appliance system of clause 41, wherein the first and second dental appliances are configured to be worn simultaneously on the upper dental arch.

Clause 43: The dental appliance system of clause 41, wherein the first, second and third dental appliances are configured to be worn simultaneously on the upper and lower dental arches.

Clause 44: The dental appliance system of clause 41, wherein each of the first, second and third dental appliances are configured to be removable from respective upper and lower dental arches.

Clause 45: The dental appliance system of clause 41, wherein the first dental appliance comprises: a first contact region that is shaped to contact one or more first teeth of the plurality of posterior teeth; a second contact region that is shaped to contact one or more second teeth of the plurality of posterior teeth; and an offset region that is arranged to receive one or more intermediate teeth of the plurality of posterior teeth, the one or more intermediate teeth positioned between the one or more first teeth and the one or more second teeth, wherein an inner surface of the offset region is shaped to be offset with respect to the one or more intermediate teeth such that the inner surface of the offset region does not contact the one or more intermediate teeth to allow the distalization force to transmit through the one or more intermediate teeth.

Clause 46: The dental appliance system of clause 45, wherein the first dental appliance further comprises a transpalatal region that connects the tooth receiving portion to a second tooth receiving portion and is arranged to span a palate of the upper dental arch, wherein the transpalatal region has an anterior edge that is anterior to a premolar region of the tooth receiving portion.

Clause 47: A removable dental appliance for correcting a Class III molar relationship in a patient, the appliance comprising: a right posterior section and a left posterior section, each posterior section comprising a tooth-engaging hull configured to wrap around at least a plurality of teeth of a lower arch of the patient; a tooth hull filler disposed within each posterior section, the tooth hull filler defining an occlusal surface configured to contact opposing upper arch teeth and to function as an occlusal deprogrammer and as a force transmitter for distalizing mechanics applied to the posterior teeth; a buccal lip bumper extending between the right posterior section and the left posterior section and connecting the right posterior section to the left posterior section, the lip bumper being spaced anteriorly from the anterior teeth of the lower arch to provide an anterior cutout region that leaves anterior teeth unconstrained; and at least one self-supported button formed integrally with the appliance and configured to engage an elastic for Class III bite correction; wherein the appliance is fabricated by direct additive fabrication from a digital model of the patient's dentition.

Clause 48: A removable dental appliance for correcting a Class III molar relationship in a patient, the appliance comprising: a right posterior section and a left posterior section, each posterior section comprising a tooth-engaging hull configured to wrap around at least a canine tooth, a premolar tooth, and a molar tooth of a lower arch of the patient; a tooth hull filler disposed within each posterior section, the tooth hull filler defining a substantially planar occlusal surface configured to contact opposing upper arch teeth and to function simultaneously as an occlusal deprogrammer and a force transmitter for distalizing mechanics; a lingual strip extending between and connecting the right posterior section and the left posterior section on the lingual side of the lower arch, the lingual strip being configured to provide structural rigidity sufficient to accommodate distalization forces applied to the posterior teeth; and an anterior cutout region defined between the right posterior section and the left posterior section on the buccal side, the anterior cutout region leaving the anterior teeth of the patient unconstrained to promote unconstrained posterior distalization without incisal restrictions; wherein the appliance is fabricated by direct additive fabrication from a digital model of the patient's dentition.

Clause 49: A method of fabricating a patient-specific removable dental appliance for Class III molar correction, the method comprising: obtaining a digital model of a patient's lower dental arch; generating, from the digital model, an appliance boundary by applying one or more mold region commands that define a posterior coverage region spanning at least the canine, premolar, and molar teeth and define an anterior cutout region excluding the anterior teeth; computing, for each of a plurality of tooth-hull regions within the posterior coverage region, a hull geometry that wraps the corresponding tooth and a hull filler geometry that defines an occlusal surface configured to function as an occlusal deprogrammer; defining, within the appliance boundary, a connection feature extending between a right side and a left side of the appliance, the connection feature being one of (a) a buccal lip bumper spaced from the anterior teeth or (b) a lingual strip disposed on the lingual side of the arch; applying region-specific offsets to one or more segments of the appliance boundary to customize a force system applied to one or more target teeth; and directly fabricating the appliance by an additive manufacturing process using the computed appliance geometry.

Clause 50: The removable dental appliance of clause 47 or clause 48, wherein the tooth hull filler comprises an internal cusp-matching occlusal feature configured to selectively provide at least one of: (a) full cusp contact with one or more opposing cusps; (b) full cusp clearance from one or more opposing cusps; (c) selective cusp contact to promote intrusion or extrusion of a target tooth; or (d) selective cusp contact to promote mesial or distal root control of a target tooth.

Clause 51: The removable dental appliance of clause 47 or clause 48, wherein an occlusal thickness of the tooth hull filler is varied along the appliance to open the patient's bite and provide anterior collision avoidance clearance between upper and lower incisors during anterior-posterior jaw movement.

Clause 52: The removable dental appliance of clause 51, wherein the occlusal thickness is provided at least in part by a hollow internal feature, a predominantly hollow internal feature reinforced with internal ribs, or a combination thereof, to reduce material consumption while maintaining structural integrity.

Clause 53: The removable dental appliance of clause 47 or clause 48, wherein the tooth hull filler further comprises at least one canine bite ramp configured to counteract canine extrusion resulting from elastic force applied during Class III bite correction.

Clause 54: The removable dental appliance of clause 47 or clause 48, wherein a degree of tooth wrapping of each tooth-engaging hull is individually customizable to adjust appliance retention and force transmission at each wrapped tooth.

Clause 55: The removable dental appliance of clause 47 or clause 48, wherein the appliance comprises a selectively applied additive material region on the mesial aspect of one or more canine or molar teeth to provide tipping control of those teeth during distalization.

Clause 56: The removable dental appliance of clause 47, wherein at least one of a width, a thickness, and an anterior separation distance of the buccal lip bumper is customized based on patient anatomy, a target appliance stiffness, or a treatment progression stage.

Clause 57: The removable dental appliance of clause 48, wherein at least one of a width, a thickness, and an anterior separation distance of the lingual strip is customized based on patient anatomy, a target appliance stiffness, or a treatment progression stage.

Clause 58: The removable dental appliance of clause 47, wherein the buccal lip bumper is configured to transmit a distalization force derived from the patient's lower lip musculature to the posterior sections.

Clause 59: The removable dental appliance of clause 47 or clause 48, wherein the at least one self-supported button is formed as an integral, unitary feature of the appliance and is positioned on a buccal or labial surface at a location determined from the digital model of the patient's dentition.

Clause 60: The removable dental appliance of clause 50, wherein the internal cusp-matching occlusal feature is configured to provide a stopping surface that prevents gingival displacement of the appliance during biting, thereby maintaining engagement of any attachments on the patient's teeth and avoiding gingival impingement.

Clause 61: The removable dental appliance of clause 47 or clause 48, wherein the appliance is a single, unitary structure produced by additive manufacturing from a biocompatible polymer material.

Clause 62: The removable dental appliance of clause 47 or clause 48, wherein the appliance is one of a series of patient-specific appliances, each appliance in the series having at least one of: (a) a different occlusal thickness of the tooth hull filler; (b) a different region-specific offset applied to one or more tooth-hull regions; or (c) a different connection feature width or thickness; whereby the series of appliances provides progressive Class III correction and simultaneous orthodontic tooth movement.

Clause 63: The method of clause 49, wherein generating the appliance boundary comprises applying a boundary envelope command defining a buccal strip region between a first tooth and a last tooth of the posterior coverage region, and applying an offset command to control a distance between an inner surface of the strip region and the patient's gingiva.

Clause 64: The method of clause 63, further comprising applying a thickness command to control a wall thickness of the buccal strip region.

Clause 65: The method of clause 49, wherein generating the appliance boundary further comprises applying a subtraction Boolean operation to remove an interproximal region between a first tooth pair and a second tooth pair from the initial boundary, and applying an addition Boolean operation to add a buccal envelope strip region to the modified boundary.

Clause 66: The method of clause 49, wherein computing the hull filler geometry comprises computing, for one or more target teeth, an internal cusp-matching feature that selectively provides cusp contact, cusp clearance, or a combination thereof to achieve at least one of intrusion, extrusion, or mesial/distal root control of the target tooth without requiring a separate bonded attachment on the target tooth.

Clause 67: The method of clause 49, further comprising varying an occlusal thickness parameter of the hull filler across one or more stages of a treatment sequence to provide anterior bite opening sufficient to achieve clearance between the patient's upper and lower anterior teeth during anterior-posterior jaw movement.

Clause 68: The method of clause 49, further comprising generating, from the digital model, a self-supported button geometry at a buccal or labial surface location determined by the patient's anatomy, the button being configured to engage an elastic for Class III bite correction, and incorporating the button geometry as a unitary feature of the appliance during the additive manufacturing process.

Clause 69: The method of clause 49, wherein applying region-specific offsets comprises applying a first offset to a mesial segment of one or more canine or molar tooth-hull regions to provide tipping control during distalization.

Clause 70: A removable dental appliance for correcting a molar relationship in a patient, the appliance comprising: a right posterior section and a left posterior section, each posterior section comprising a tooth-engaging hull configured to wrap around at least one posterior tooth of a dental arch of the patient; a tooth hull filler disposed within each posterior section, the tooth hull filler defining an occlusal surface configured to contact opposing arch teeth and to function as an occlusal deprogrammer and a force transmitter for distalizing mechanics; a connection feature extending between the right posterior section and the left posterior section, the connection feature defining an anterior cutout region that leaves the anterior teeth of the arch unconstrained; and at least one self-supported button formed integrally with the appliance and configured to engage an elastic for bite correction; wherein the appliance is patient-specifically fabricated by direct additive fabrication from a digital model of the patient's dentition, and wherein the tooth hull filler and connection feature are customizable in geometry to adjust a force system applied to one or more target teeth based on patient anatomy or treatment progression.

Clause 71: The removable dental appliance of clause 70, wherein the dental arch is a lower arch and the molar relationship is a Class III molar relationship, and the connection feature is a buccal lip bumper configured to transmit a distalization force from the patient's lower lip.

Clause 72: The removable dental appliance of clause 70, wherein the dental arch is a lower arch and the molar relationship is a Class III molar relationship, and the connection feature is a lingual strip disposed on the lingual side of the arch.

Clause 73: The removable dental appliance of clause 70, wherein the dental arch is an upper arch and the molar relationship is a Class II molar relationship.

Clause 74: A Class III orthodontic distalizer appliance, comprising: a monolithic, patient‑specific polymer body configured to be removably worn on a lower dental arch of a subject; a posterior tooth‑receiving portion shaped to wrap a plurality of posterior mandibular teeth including at least premolars and molars; an anterior opening configured to avoid contact with one or more anterior mandibular teeth; one or more elastic engagement structures integrally formed with the polymer body and configured to engage Class III elastics to apply a distalization force to the posterior mandibular teeth; and an offset region within the posterior tooth‑receiving portion, the offset region having an inner surface shaped to be spaced from at least one posterior tooth to permit force‑driven distal movement of the posterior teeth, wherein the appliance is configured to apply distalizing forces for correction of a Class III malocclusion and is fabricated by direct additive manufacturing.

Clause 75: The appliance of clause 74, wherein the polymer body is fabricated by direct three‑dimensional printing without post‑bonded attachments.

Clause 76: The appliance of clause 74, wherein the polymer body includes region‑specific offsets customized to a treatment stage of the subject.

Clause 77: The appliance of clause 74, wherein the posterior tooth‑receiving portion comprises hull filler geometry that increases contact surface area for force transmission.

Clause 78: The appliance of clause 74, wherein the posterior tooth‑receiving portion includes a tooth hull filler forming a substantially flat occlusal surface configured to function as an occlusal deprogrammer.

Clause 79: The appliance of clause 78, wherein the flat occlusal surface promotes crown‑to‑crown force transmission between adjacent posterior teeth.

Clause 80: The appliance of clause 78, wherein the occlusal surface has increased thickness relative to buccal and lingual walls to resist gingival displacement under bite forces.

Clause 81: The appliance of clause 74, wherein the anterior opening defines a window that substantially avoids contact with mandibular incisors.

Clause 82: The appliance of clause 74, further comprising one or more canine bite ramps configured to limit canine extrusion during elastic wear.

Clause 83: The appliance of clause 82, wherein the canine bite ramps are integrally formed during direct additive manufacturing.

Clause 84: The appliance of clause 74, wherein the elastic engagement structures comprise self‑supporting buttons integrally formed on a buccal surface of the polymer body.

Clause 85: The appliance of clause 84, wherein a position of the elastic engagement structures is selected to control a force vector applied by Class III elastics.

Clause 86: The appliance of clause 74, wherein the appliance is configured to transmit distalization force from at least one elastic band anchored to a maxillary appliance.

Clause 87: The appliance of clause 74, further comprising a buccal lip bumper connecting right and left posterior regions of the polymer body.

Clause 88: The appliance of clause 87, wherein the lip bumper is offset from anterior teeth and configured to receive additional distalizing force from a lower lip of the subject.

Clause 89: The appliance of clause 87, wherein a width, thickness, or anterior separation of the lip bumper is customized during digital design.

Clause 90: The appliance of clause 74, further comprising a lingual strip connecting right and left posterior regions of the polymer body.

Clause 91: The appliance of clause 90, wherein the lingual strip is offset from lingual surfaces of anterior teeth to minimize anterior tooth contact.

Clause 92: The appliance of clause 90, wherein the lingual strip provides structural rigidity to resist deformation during Class III elastic loading.

Clause 93: The appliance of clause 74, wherein the right and left posterior regions are mechanically connected to reduce a choking hazard.

Clause 94: The appliance of clause 74, wherein the appliance includes selective additive material at one or more regions to control mesial tipping of molars.

Clause 95: The appliance of clause 74, wherein the appliance geometry is modified across successive treatment stages to accommodate treatment progression.

Clause 96: A method of correcting a Class III malocclusion, comprising: digitally designing a patient‑specific Class III distalizer appliance according to any of clauses 74-95; directly fabricating the appliance by additive manufacturing; placing the appliance on a lower dental arch of a subject; and applying Class III elastics to the elastic engagement structures to distalize posterior mandibular teeth while limiting anterior tooth interference.

What is claimed is:

1. A dental appliance, comprising:
a tooth receiving portion shaped to receive a plurality of teeth, the tooth receiving portion comprising an elastic engagement structure arranged to engage with an elastic band to apply a distalization force along the plurality of teeth, wherein the tooth receiving portion comprises:
a first contact region that is shaped to contact one or more first teeth of the plurality of teeth;
a second contact region that is shaped to contact one or more second teeth of the plurality of teeth; and
an offset region that is arranged to receive one or more intermediate teeth of the plurality of teeth, the one or more intermediate teeth positioned between the one or more first teeth and the one or more second teeth, wherein an inner surface of the offset region is shaped to be offset with respect to the one or more intermediate teeth such that the inner surface of the offset region does not contact the one or more intermediate teeth to allow the distalization force to transmit through the one or more intermediate teeth.

2. The dental appliance of claim 1, wherein the dental appliance further comprises a transpalatal region that connects the tooth receiving portion to a second tooth receiving portion and is arranged to span a palate of a dental arch, wherein the transpalatal region has an anterior edge that is anterior to a premolar region of the tooth receiving portion.

3. The dental appliance of claim 1, wherein the second contact region is shaped to directly contact the one or more second teeth or indirectly contact the one or more second teeth via one or more dental attachments attached to the one or more second teeth.

4. The dental appliance of claim 1, wherein a distance between opposite inner surfaces on a buccal side and a lingual side of the offset region is greater than a distance between opposite inner surfaces of the first contact region and the second contact region.

5. The dental appliance of claim 1, wherein a height of the occlusal surface of the offset region is greater than a height of the occlusal surface of the first contact region and the second contact region.

6. The dental appliance of claim 1, wherein the second contact region is configured to apply a corrective force on the one or more second teeth, the corrective force applied in a different direction than the distalization force.

7. The dental appliance of claim 1, wherein the inner surface of the offset region comprises one or more corrective force features that is configured to engage with one or more corresponding dental attachments attached to the one or more intermediate teeth and apply one or more corrective forces on the one or more intermediate teeth.

8. The dental appliance of claim 1, wherein the one or more intermediate teeth includes a first premolar and/or a second premolar of the plurality of teeth.

9. The dental appliance of claim 1, wherein the second contact region is configured to contact a buccal surface, a lingual surface or a buccal and lingual surface of the one or more second teeth.

10. The dental appliance of claim 1, wherein the second contact region includes a lingual wall and a buccal wall that encompass the one or more second teeth, wherein at least one of the lingual and buccal walls contact the one or more second teeth.

11. The dental appliance of claim 1, wherein the tooth receiving portion includes an elastic engagement structure that is configured to engage with the elastic band, wherein the elastic engagement structure is located on a buccal side of the offset region.

12. The dental appliance of claim 11, wherein the elastic engagement structure is located distal to a cavity of the tooth receiving portion that is configured to accept a canine tooth of the plurality of teeth.

13. The dental appliance of claim 11, wherein the elastic engagement structure is located distal to a cavity of the tooth receiving portion that is configured to accept a premolar tooth of the plurality of teeth.

14. The dental appliance of claim 1, wherein the tooth receiving portion includes multiple elastic engagement structures located along a buccal side of the tooth receiving portion, wherein each of the multiple elastic engagement structures is configured to engage with the elastic band.

15. The dental appliance of claim 14, wherein the dental appliance is configured to apply the distalization force when two or more elastic bands are coupled with corresponding two or more of the multiple elastic engagement structures at the same time.

16. The dental appliance of claim 1, wherein the tooth receiving portion is a first tooth receiving portion that is shaped to accept a first plurality of teeth on a first side of a dental arch, wherein the dental appliance further comprises:
a second tooth receiving portion that is shaped to accept a second plurality of teeth on a second side of the dental arch; and
a transpalatal region that is coupled with the first and second tooth receiving portions.

17. The dental appliance of claim 16, wherein the transpalatal region has a varied thickness along a buccal-lingual axis and/or a posterior-anterior axis.

18. The dental appliance of claim 1, wherein the offset region includes an occlusal cutout that is arranged to expose occlusal surfaces of the one or more intermediate teeth.

19. A method of distalizing a subject’s teeth, the method comprising:
applying a dental appliance over a subject’s upper dental arch such that a plurality of teeth of the subject’s upper dental arch are received in a tooth receiving portion of the dental appliance, wherein the tooth receiving portion contacts one or more first teeth of the plurality of teeth and one or more second teeth of the plurality of teeth, wherein an offset region of the tooth receiving portion includes an inner surface that is offset with respect to one or more intermediate teeth between the one or more first and second teeth; and
coupling an elastic band to an attachment site on the dental appliance and to an attachment site on the subject’s lower jaw to apply a distalization force that is transmitted through one or more intermediate teeth of the subject’s upper dental arch.

20. A dental appliance, comprising:
a tooth receiving portion shaped to receive a plurality of teeth, the tooth receiving portion comprising an elastic engagement structure arranged to engage with an elastic band to apply a distalization force along the plurality of teeth, wherein the tooth receiving portion comprises:
an offset region that is arranged to receive one or more teeth of the plurality of teeth that are to be distalized, wherein an inner surface of the offset region is shaped to be offset with respect to the one or more teeth such that the inner surface of the offset region does not contact the one or more teeth to allow the distalization force to transmit through the one or more teeth; and
a dental attachment engagement feature that protrudes from the inner surface of the offset region and is arranged to engage with a dental attachment bonded to a target tooth of the one or more teeth to apply a corrective force on the target tooth, wherein the corrective force is in a different direction than the distalization force.
